(19) United States
(12) Patent Application Publication
(10) Pub. No.: US 2005/0009608 A1
(43) Pub. Date: Jan. 13, 2005

(54) Commerce-enabled environment for interacting with simulated phenomena

(75) Inventors: James O. Robarts, Redmond, WA (US); Cesar A. Alvarez, Kirkland, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Consolidated Global Fun Unlimited, Redmond, WA (US)

(21) Appl. No.: 10/845,584

(22) Filed: May 13, 2004

Related U.S. Application Data
(63) Continuation-in-part of application No. 10/438,172, filed on May 13, 2003.
(60) Provisional application No. 60/470,394, filed on May 13, 2003.
(60) Provisional application No. 60/380,552, filed on May 13, 2002.

(51) Int. Cl. G09G 5/00; G06F 19/00; G06F 17/00

(52) U.S. Cl. 463/42

(57) ABSTRACT

Methods and systems for interacting with simulated phenomena are provided. Example embodiments provide a Simulated Phenomena Interaction System “SPIS,” which enables a user to incorporate simulated phenomena into the user's real world environment by interacting with the simulated phenomena. In one embodiment, the SPIS comprises a mobile environment (e.g., a mobile device) and a simulation engine. The mobile environment may be configured as a thin client that remotely communicates with the simulation engine, or it may be configured as a fat client that incorporates one or more of the components of the simulation engine into the mobile device. These components cooperate to define the characteristics and behavior of the simulated phenomena and interact with users via mobile devices. The characteristics and behavior of the simulated phenomena are based in part upon values sensed from the real world, thus achieving a more integrated correspondence between the real world and the simulated world. Interactions, such as detection, measurement, communication, and manipulation, typically are initiated by the mobile device and responded to by the simulation engine based upon characteristics and behavior of the computer-generated and maintained simulated phenomena.

### BACKGROUND OF THE INVENTION

1. Field of the Invention

The present invention relates to methods and systems for incorporating computer-controlled representations into a real world environment and, in particular, to methods and systems for using a mobile device to interact with simulated phenomena.

2. Background Information

Computerized devices, such as portable computers, wireless phones, personal digital assistants (PDAs), global positioning system devices (GPSes) etc., are becoming compact enough to be easily carried and used while a user is mobile. They are also becoming increasingly connected to communication networks over wireless connections and other portable communications media, allowing voice and data to be shared with other devices and other users while being transported between locations. Interestingly enough, although such devices are also able to determine a variety of aspects of the user's surroundings, including the absolute location of the user, and the relative position of other devices, these capabilities have not yet been well integrated into applications for these devices.

For example, applications such as games have been developed to be executed on such mobile devices. They are typically downloaded to the mobile device and executed solely from within that device. Alternatively, there are multi-player network based games, which allow a user to “log-in” to a remotely-controlled game from a portable or mobile device; however, typically, once the user has logged-on, the narrative of such games is independent from any environment-sensing capabilities of the mobile device. At most, a user's presence through addition of an avatar that represents the user may be indicated in an on-line game to other mobile device operators. Puzzle type gaming applications have also been developed for use with some portable devices. These games detect a current location of a mobile device and deliver “clues” to help the user find a next physical item (like a scavenger hunt).

GPS mobile devices have also been used with navigation system applications such as for nautical navigation. Typical of these applications is the idea that a user indicates to the navigation system a target location for which the user wishes to receive an alert. When the navigation system detects (by the GPS coordinates) that the location has been reached, the system alerts the user that the target location has been reached.

Computerized simulation applications have also been developed to simulate a nuclear, biological, or chemical weapon using a GPS. These applications mathematically represent, in a quantifiable manner, the behavior of dispersion of the weapon's damaging forces (for example, the detection area is approximated from the way the wind carries the material emanating from the weapon). A mobile device is then used to simulate detection of this damaging force when the device is transported to a location within the dispersion area.

None of these applications take advantage of or integrate a device's ability to determine a variety of aspects of the user's surroundings.

### BRIEF SUMMARY OF THE INVENTION

Embodiments of the present invention provide enhanced computer- and network-based methods and systems for interacting with simulated phenomena using mobile devices. Example embodiments provide a Simulated Phenomena Interaction System (“SPIS”), which enables users to enhance their real world activity with computer-generated and computer-controlled simulated entities, circumstances, or events, whose behavior is at least partially based upon the real world activity taking place. The Simulated Phenomena Interaction System is a computer-based environment that can be used to offer an enhanced gaming, training, or other simulation experience to users by allowing a user's actions to influence the behavior of the simulated phenomenon including the simulated phenomenon's simulated responses to interactions with the simulated phenomenon. In addition, the user's actions may influence or modify a simulation's narrative, which is used by the SPIS to assist in controlling interactions with the simulated phenomenon, thus providing an enriched, individualized, and dynamic experience to each user.

In one example embodiment, the Simulated Phenomena Interaction System comprises one or more functional components/modules that work together to support a single or multi-player computer gaming environment that uses one or more mobile devices to “play” with one or more simulated phenomena according to a narrative. The narrative is potentially dynamic and influenced by players' actions, external persons, as well as the phenomena being simulated. In another example embodiment, the Simulated Phenomena Interaction System comprises one or more functional components/modules that work together to provide a hands-on training environment that simulates real world situations, for example dangerous or hazardous situations such as contaminant detection and containment, in a manner that safely allows operators trial experiences that more accurately reflect real world behaviors.

For example, a Simulated Phenomena Interaction System may comprise a mobile device or other mobile computing environment and a simulation engine. The mobile device is typically used by an operator to indicate interaction requests with a simulated phenomenon. The simulation engine responds to such indicated requests by determining whether the indicated interaction request is permissible and performing the interaction request if deemed permissible. For example, the simulation engine may further comprise a narrative with data and event logic, a simulated phenomena characterizations data repository, and a narrative engine (e.g., to implement a state machine). The narrative engine typically uses the narrative and simulated phenomena characterizations data repository to determine whether an indicated interaction is permissible, and, if so, to perform that interaction with a simulated phenomenon. In addition, the simulation engine may comprise other data repositories or store other data that characterizes the state of the mobile device, information about the operator/player, the state of the narrative, etc. Separate modeling components may also be present to perform complex modeling of simulated phenomena, the environment, the mobile device, the user, etc.

According to one approach, interaction between a user and a simulated phenomena (SP) occurs when the device sends an interaction request to a simulation engine and the simulation engine processes the requested interaction with the SP by changing a characteristic of some entity within the simulation (such as an SP, the narrative, an internal model of the device or the environment, etc.) and/or by responding to the device in a manner that evidences “behavior” of the SP. In some embodiments, interaction operations include detection of, measurement of, communication with, and manipulation of a simulated phenomenon. In one embodiment, the processing of the interaction request is a function of an attribute of the SP, an attribute of the mobile device that is based upon a real world physical characteristic of the device or the environment, and the narrative. For example, the physical characteristic of the device may be its physical location. In some embodiments the real world characteristic is determined by a sensing device or sensing function. The sensing device/function may be located within the mobile device or external to the device in a transient, dynamic, or static location.

According to another approach, the SPIS is used by multiple mobile environments to provide competitive or cooperative behavior relative to a narrative of the simulation engine.

### BRIEF DESCRIPTION OF THE DRAWINGS

FIG. 1 is a block diagram of a Simulated Phenomena Interaction System used to enhance the real world environment.

FIG. 2 is a block diagram of an overview of example Simulated Phenomena Interaction System in operation.

FIG. 3 is an example mobile device display of the results of an interaction request to a simulation engine used in a game, which involves both detection and measurement of simulated phenomena.

FIG. 4 is an example mobile device display of the results of an interaction request to a simulation engine used in a game, which involves communication with a simulated phenomenon.

FIG. 5 is an example mobile device display of the results of an interaction request to a simulation engine used in a game, which involves manipulation of a simulated phenomenon.

FIG. 6 is an example block diagram of components of an example Simulated Phenomena Interaction System.

FIG. 7 is an example block diagram of an alternative embodiment of components of an example simulation engine.

FIG. 8 is an overview flow diagram of example steps to process interaction requests within a simulation engine of a Simulated Phenomena Interaction System.

FIG. 9 is an overview flow diagram of example steps to process interactions within a mobile device used with a Simulated Phenomena Interaction System.

FIG. 10 is an example block diagram of a general purpose computer system for practicing embodiments of a simulation engine of a Simulated Phenomena Interaction System.

FIG. 11 illustrates an embodiment of a “thin” client mobile device, which interacts with a remote simulation engine running for example on a general purpose computer system, as shown in FIG. 10.

FIG. 12 illustrates an embodiment of a “fat” client mobile device in which one or more portions of the simulation engine reside as part of the mobile device environment itself.

FIG. 13 is an example block diagram of an event loop for an example simulation engine of a Simulated Phenomena Interaction System.

FIG. 14 is an example flow diagram of an example detection interaction routine provided by a simulation engine of a Simulated Phenomena Interaction System.

FIG. 15 is an example diagram illustrating simulation engine modeling of a mobile device that is able to sense its location by detecting electromagnetic broadcasts.

FIG. 16 is an example illustration of an example field of vision on a display of a wearable device.

FIG. 17 is an example diagram illustrating simulation engine modeling of a mobile device enhanced with infrared capabilities whose location is sensed by infrared transceivers.

FIG. 18 is an example illustration of a display on a mobile device that indicates the location of a simulated phenomenon relative to a user's location as a function of the physical location of the mobile device.

FIG. 19 contains a set of diagrams illustrating different ways to determine and indicate the location of a simulated phenomenon relative to a user when a device has a different physical range from its apparent range as determined by the simulation engine.

FIG. 20 is an example flow diagram of an example measurement interaction routine provided by a simulation engine of a Simulated Phenomena Interaction System.

FIG. 21 is an example flow diagram of an example communicate interaction routine provided by a simulation engine of a Simulated Phenomena Interaction System.

FIG. 22 is an example flow diagram of an example manipulation interaction routine provided by a simulation engine of a Simulated Phenomena Interaction System.

FIG. 23 is an example block diagram of an authoring system used with the Simulated Phenomena Interaction System.

FIG. 24 is an example block diagram of an example Simulated Phenomena Interaction System integrated into components of a commerce-enabled environment.

FIG. 25 is an overview flow diagram of example steps to process spectator requests within a simulation engine of a Simulated Phenomena Interaction System.

### DETAILED DESCRIPTION OF THE INVENTION

Embodiments of the present invention provide enhanced computer- and network-based methods and systems for interacting with simulated phenomena using mobile devices. Example embodiments provide a Simulated Phenomena Interaction System (“SPIS”), which enables users to enhance their real world activity with computer-generated and computer-controlled simulated entities, circumstances, or events, whose behavior is at least partially based upon the real world activity taking place. The Simulated Phenomena Interaction System is a computer-based environment that can be used to offer an enhanced gaming, training, or other simulation experience to users by allowing a user's actions to influence the behavior of the simulated phenomenon including the simulated phenomenon's simulated responses to interactions with the simulated phenomenon. In addition, the user's actions may influence or modify a simulation's narrative, which is used by the SPIS to assist in controlling interactions with the simulated phenomenon, thus providing an enriched, individualized, and dynamic experience to each user.

For the purposes of describing a Simulated Phenomena Interaction System, a simulated phenomenon includes any computer software controlled entity, circumstance, occurrence, or event that is associated with the user's current physical world, such as persons, objects, places, and events. For example, a simulated phenomenon may be a ghost, playmate, animal, particular person, house, thief, maze, terrorist, bomb, missile, fire, hurricane, tornado, contaminant, or other similar real or imaginary phenomenon, depending upon the context in which the SPIS is deployed. Also, a narrative is sequence of events (a story—typically with a plot), which unfold over time. For the purposes herein, a narrative is represented by data (e.g., the current state and behavior of the characters and the story) and logic which dictates the next “event” to occur based upon specified conditions. A narrative may be rich, such as a unfolding scenario with complex modeling capabilities that take into account physical or imaginary characteristics of a mobile device, simulated phenomena, and the like. Or, a narrative may be more simplified, such as merely the unfolding of changes to the location of a particular simulated phenomenon over time.

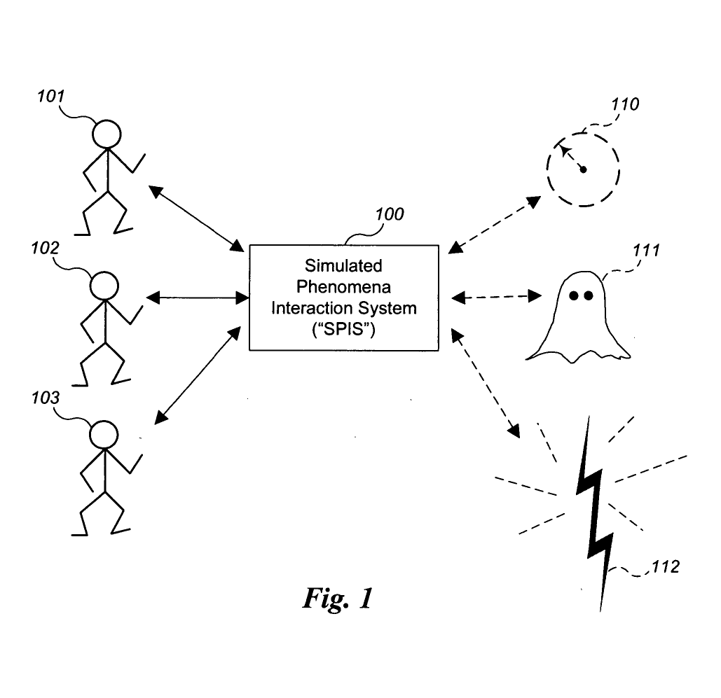

FIG. 1 is a block diagram of a Simulated Phenomena Interaction System used to enhance the real world environment. In FIG. 1, operators 101, 102, and 103 interact with the Simulated Phenomena Interaction System (“SPIS”) 100 to interact with simulated phenomenon of many forms. For example, FIG. 1 shows operators 101, 102, and 103 interacting with three different types of simulated phenomena: a simulated physical entity, such as a metering device 110 that measures the range of how close a simulated phenomena is to a particular user; an imaginary simulated phenomenon, such as a ghost 111; and a simulation of a real world event, such as a lightning storm 112. Note that, for the purposes of this description, the word “operator” is used synonymously with user, player, participant, etc. Also, one skilled in the art will recognize that a system such as the SPIS can simulate basically any real or imaginary phenomenon providing that the phenomenon's state and behavior can be specified and managed by the system.

In one example embodiment, the Simulated Phenomena Interaction System comprises one or more functional components/modules that work together to support a single or multi-player computer gaming environment that uses one or more mobile devices to “play” with one or more simulated phenomena according to a narrative. The narrative is potentially dynamic and influenced by players' actions, external personnel, as well as the phenomena being simulated. One skilled in the art will recognize that these components may be implemented in software or hardware or a combination of both. In another example embodiment, the Simulated Phenomena Interaction System comprises one or more functional components/modules that work together to provide a hands-on training environment that simulates real world situations, for example dangerous or hazardous situations, such as contaminant and air-born pathogen detection and containment, in a manner that safely allows operators trial experiences that more accurately reflect real world behaviors. In another example embodiment, the Simulated Phenomena Interaction System one or more functional components/modules that work together to provide a commerce-enabled application that generates funds for profit and non-profit entities. For example, in one embodiment, spectators are defined that can participate in an underlying simulation experience by influencing or otherwise affecting interactions with Simulated Phenomena Interaction System based upon financial contributions to a charity or to a for-profit entity.

For use in all such simulation environments, a Simulated Phenomena Interaction System comprises a mobile device or other mobile computing environment and a simulation engine. The mobile device is typically used by an operator to indicate interaction requests with a simulated phenomenon. The simulation engine responds to such indicated requests by determining whether the indicated interaction request is permissible and performing the interaction request if deemed permissible. The simulation engine comprises additional components, such as a narrative engine and various data repositories, which are further described below and which provide sufficient data and logic to implement the simulation experience. That is, the components of the simulation engine implement the characteristics and behavior of the simulated phenomena as influenced by a simulation narrative.

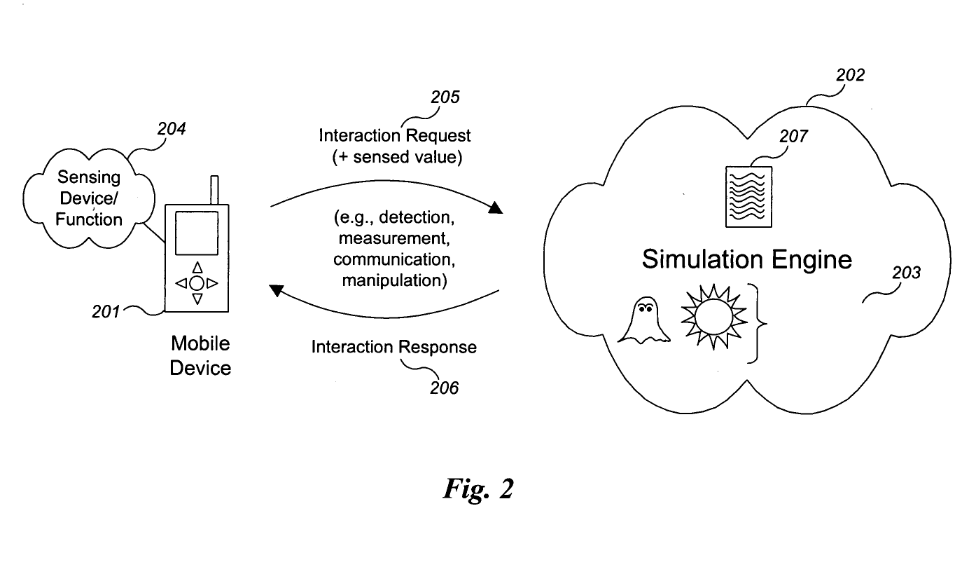

FIG. 2 is a block diagram of an overview of example Simulated Phenomena Interaction System in operation. In FIG. 2, the Simulated Phenomena Interaction System (SPIS) includes a mobile device 201 shown interacting with a simulation engine 202. Mobile device 201 forwards (sends or otherwise indicates, depending upon the software and hardware configuration) an interaction request 205 to the simulation engine 202 to interact with one or more simulated phenomena 203. The interaction request 205 specifies one or more of the operations of detection, measurement, communication, and manipulation. These four operations are the basic interactions supported by the Simulated Phenomena Interaction System. One skilled in the art will recognize that other interactions may be defined separately or as subcomponents, supersets, or aggregations of these operations, and the choice of operations is not intended to be exclusive. In one embodiment of the system, at least one of the interaction requests 205 to the simulation engine 202 indicates a value that has been sensed by some device or function 204 in the user's real world. Sensing function/device 204 may be part of the mobile device 201, or in proximity of the mobile device 201, or completely remote to the location of both the mobile device 201 and/or the simulation engine 202. Once the interaction request 205 is received by simulation engine 202, the simulation engine determines an interaction response 206 to return to the mobile device 201, based upon the simulated phenomena 203, the previously sensed value, and a narrative 207 associated with the simulation engine 202. The characterizations (attribute values) of the simulated phenomena 203, in cooperation with events and data defined by the narrative 207, determine the appropriate interaction response 206. Additionally, the simulation engine 202 may take other factors into account in generating the interaction response 206, such as the state of the mobile device 201, the particular user initiating the interaction request 205, and other factors in the simulated or real world environment. At some point during the processing of the interaction request 205, the simulation provided by simulation engine 202 is affected by the sensed value and influences the interaction response 206. For example, the characterizations of the simulated phenomena 203 themselves may be modified as a result of the sensed value; an appropriate interaction response selected based upon the sensed value; or the narrative logic itself modified as a result. Other affects and combinations of affects are possible.

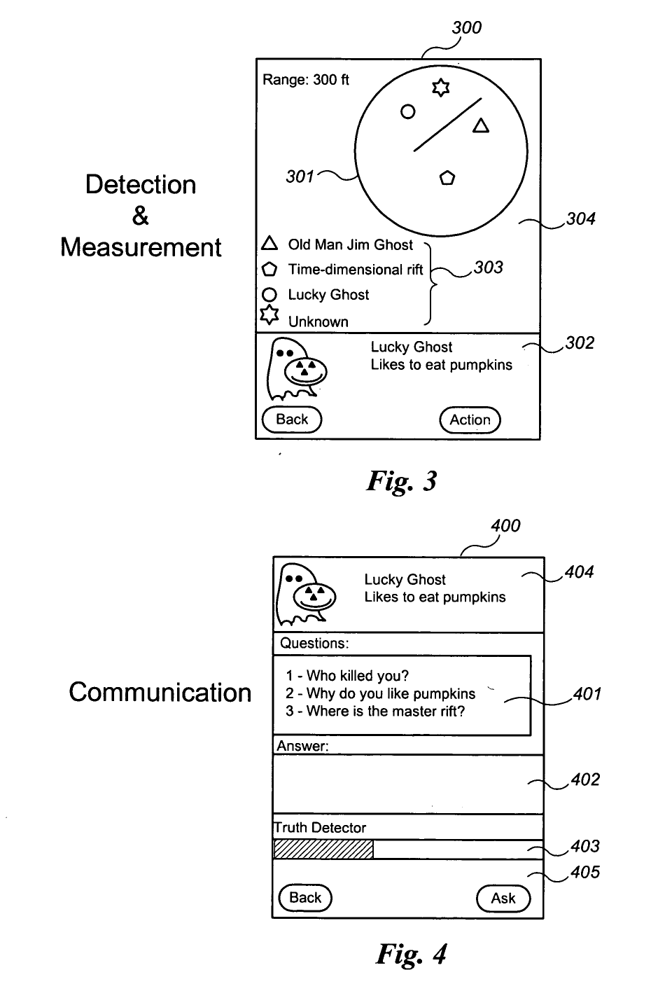

FIGS. 3, 4, and 5 are example mobile device displays associated with interaction requests and responses in a gaming environment. These figures correspond to an example embodiment of a gaming system, called “Spook,” that incorporates techniques of the methods and systems of the Simulated Phenomena Interaction System to enhance the gaming experience. A more comprehensive description of examples from the Spook game is included as Appendix A, which is herein incorporated by reference in its entirety. In summary, Spook defines a narrative in which ghosts are scattered about a real world environment in which the user is traveling with the mobile device, for example, a park. The game player, holding the mobile device while traveling, interacts with the game by initiating interaction requests and receiving feedback from the simulation engine that runs the game. In one example, the player's goal is to find a particular ghost so that the ghost can be helped. In that process, the player must find all the other ghosts and capture them in order to enhance the detection capabilities of the detection device so that it can detect the particular ghost. As the player travels around the park, the ghosts are detected (and can be captured) depending upon the actual physical location of the player in the park. The player can also team up with other players (using mobile devices) to play the game.

FIG. 3 is an example mobile device display of the results of an interaction request to a simulation engine used in a game, which involves both detection and measurement of simulated phenomena. Mobile device 300 includes a detection and measurement display area 304 and a feedback and input area 302. In FIG. 3, mobile device 300 shows the results of interacting with a series of ghosts (the simulated phenomena) as shown in detection and measurement display area 304. The interaction request being processed corresponds to both detection and measurement operations (e.g., “show me where all the ghosts are”). In response to this request, the simulation engine sends back information regarding the detected simulated phenomena (“SPs”) and where they are relative to the physical location of the mobile device 300. Accordingly, the display area 304 shows a “spectra-meter” 301 (a spectral detector), which indicates the locations of each simulated phenomena (“SP”) that was detectable and detected by the device 300. In this example, the line of the spectra-meter 301 indicates a direction of travel of the user of the mobile device 300 and the SPs' locations are relative to device location. An observation “key” to the detected SPs is shown in key area 303. The display area 304 also indicates that the current range of the spectra-meter 301 is set to exhibit a 300 foot range of detection power. (One skilled in the art will recognize that this range may be set by the simulation engine to be different or relative to the actual physical detection range of the device—depending upon the narrative logic and use of SPIS.) Using the current range, the spectra-meter 301 has detected four different ghosts, displayed in iconic form by the spectra-meter 301. As a result of the detection and measurement request, the simulation engine has also returned feedback (in the form of a hint) to the user which is displayed in feedback and input area 302. This hint indicates a current preference of one of the ghosts called “Lucky Ghost.” The user can then use this information to learn more about Lucky Ghost in a future interaction request (see FIG. 4). Once skilled in the art will recognize that the behaviors and indications shown by mobile device 300 are merely examples, and that any behavior and manner of indicating location of an SP is possible as long as it can be implemented by the SPIS. For example, the pitch of an audio tone, other visual images, or tactile feedback (e.g., device vibration), may be used to indicate the presence of and proximity of a ghost. In addition, other attributes that characterize the type of phenomenon being detected, such as whether the SP is friendly or not, may also be shown.

FIG. 4 is an example mobile device display of the results of an interaction request to a simulation engine used in a game, which involves communication with a simulated phenomenon. Mobile device 400 includes a question area 401, an answer area 402, and a special area 403, which is used to indicate a reliability measurement of the information just received from the ghosts. Mobile device 400 also includes an indication of the current SP being communicated with in the header area 404 (here the “Lucky Ghost”). In the specific example shown, the operator selects between the three questions displayed in question area 401, using whatever navigational input is available on the mobile device 400 (such as arrow keys in combination with the buttons in input area 405). One skilled in the art will recognize that, using other types of mobile devices, alternate means for input and thus alternative indication of communications is possible and desirable. For example, using a device with a keyboard, the user might type in (non preformed) questions that utilize a system of keyword matching. A response, which is not shown, would be displayed by mobile device 400 in the answer area 402 when it is received from the simulation engine. Also, the truth detector shown in special area 403 would register a value (not shown) indicating the reliability of the SP response.

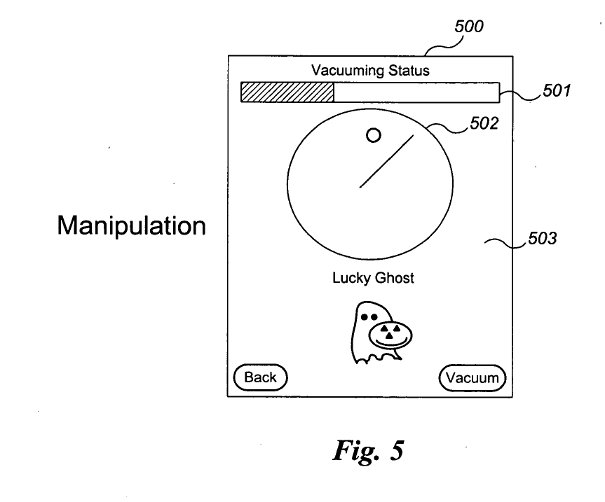

FIG. 5 is an example mobile device display of the results of an interaction request to a simulation engine used in a game, which involves manipulation of a simulated phenomenon. Mobile device 500 includes a feedback and input area 503. In FIG. 5, mobile device 500 illustrates the result of performing a “vacuuming operation” on a previously located ghost. Vacuuming is a manipulation operation provide by the Spook game to allow a user a means of capturing a ghost. The spectra-meter 502 shows the presence of a ghost (SP) currently to the left of the direction the user is traveling. Depending upon the rules of the narrative logic of the game, the ghost may be close enough to capture. When the user initiates a vacuuming operation with the simulation engine, then the vacuuming status bar area 501 is changed to show the progress of vacuuming up the ghost. If the ghost is not within manipulation range, this feedback (not shown) is displayed in the feedback and input area 503.

In a hands-on training-environment that simulates real world situations, such as a contaminant detection simulation system, the interaction requests and interaction responses and processed by the mobile device are appropriately modified to reflect the needs of the simulation. For example, techniques of the Simulated Phenomena Interaction System may be used to provide training scenarios which address critical needs related to national security, world health, and the challenges of modern peacekeeping efforts. In one example embodiment, the SPIS is used to create a Biohazard Detection Training Simulator (BDTS) that can be used to train emergency medical and security personnel in the use of portable biohazard detection and identification units in a safe, convenient, affordable, and realistic environment. A further description of this example use and an example training scenario is included in Appendix B, which is herein incorporated by reference in its entirety.

This embodiment simulates the use of contagion detector devices that have been developed using new technologies to detect pathogens and contagions in a physical area. Example devices include BIOHAZ, FACSCount, LUMINEX 100, ANALYTE 2000, BioDetector (BD), ORIGEN Analyzer, and others, as described by the Bio-Detector Assessment Report prepared by the U.S. Army Edgewood Chemical, Biological Center (ERT Technical Bulletin 2001-4), which is herein included by reference in its entirety. Since it is prohibitively expensive to install such devices in advance everywhere they may be needed in the future, removing them from commission for training emergency personnel is not practical. Thus, BDTSs can be substituted for training purposes. These BDTSs need to simulate the pathogen and contagion detection technology as well as the calibration of a real contagion detector device and any substances needed to calibrate or operate the device. In addition, the narrative needs to be constructed to simulate field conditions and provide guidance to increase the awareness of proper personnel protocol when hazardous conditions exist.

In addition to gaming and hazardous substance training simulators, one skilled in the art will recognize, that the techniques of the Simulated Phenomena Interaction System may be useful to create a variety of other simulation environments, including response training environments for other naturally occurring phenomenon, for example, earthquakes, floods, hurricanes, tornados, bombs, and the like. Also, these techniques may be used to enhance real world experiences with more “game-like” features. For example, a SPIS may be used to provide computerized (and narrative based) routing in an amusement park with rides or other facility so that a user's experience is optimized to frequent rides with the shortest waiting times. In this scenario, the SPIS acts as a “guide” by placing SPs in locations (relative to the user's physical location in the park) that are strategically located relative to the desired physical destination. The narrative, as evidenced by the SPs behavior and responses, encourages the user to go after the strategically placed SPs. The user is thus “led” by the SPIS to the desired physical destination and encouraged to engage in desired behavior (such as paying for the ride) by being “rewarded” by the SPIS according to the narrative (such as becoming eligible for some real world prize once the state of the mobile device is shown to a park operator). Many other gaming, training, and computer aided learning experiences can be similarly presented and supported using the techniques of a Simulated Phenomena Interaction System.

Any such SPIS game (or other SPIS simulation scenario) can be augmented by placing the game in a commerce-enabled environment that integrates with the SPIS game through defined SPIS interfaces and data structures. For example, with the inclusion of additional modules and the use of a financial transaction system (such as those systems known in the art that are available to authorize and authenticate financial transactions over the Internet), spectators of various levels can affect, for a price, the interactions of a game in progress. The price paid may go to a designated charitable organization or may provide direct payment to the game provider or some other profit-seeking entity, depending upon how the commerce-enable environment is deployed. An additional type of SPIS participant (not the operator of the mobile device) called a “spectator” is defined. A spectator, depending upon the particular simulation scenario, authentication, etc. may have different access rights that designate what data is viewable by the spectator and what parts of or how the SPIS scenario or underlying environment may be affected. A spectator's ability to affect the simulation scenario or assist a mobile device operator is typically in proportion to the price paid. In addition, a spectator may be able to provide assistance to an individual participant or a team. For example, a narrative “hint” may be provided to the designated operator of a mobile device (the “game participant”) in exchange for the receipt of funds from the spectator. Further, the price of such assistance may vary according to the current standing of the game participant relative to the competition or some level to be attained. Thus, the spectator is given access to such information to facilitate a contribution decision.

Different “levels” of spectators may be defined, for example, by specifying a plurality of “classes” (as in the object-oriented term, or equivalents thereto) of spectators that own or inherit a set of rights. These rights dictate what types of data are viewable from, for example, the SPIS data repositories. The simulation engine is then responsible to abide by the specified access right definitions once a spectator is recognized as belonging to a particular spectator class. One skilled in the art will recognize that other simulation participants, such as a game administrator, an operator (game participant), or a member of a team can also be categorized as belonging to a participant level that defines the participants access rights.

In one example embodiment of a commerce-enabled environment, five classes of spectators (roles) are defined as having the following access rights:

(1) Participant (Operator(s) of a Mobile Device):

Participants have access to all data relevant to their standing in the game (includes their status within the narrative context). They also have access to their competitor's status as if they are an anonymous spectator. They may keep data that they explicitly generate, such as notes, private from anyone else.

(2) Team Member:

A Team Member has a cooperative relationship with the Participant and thus has access to all Participant data except private notes. Also may have access to all streaming data such as audio and/or video generated by any simulation scenario participants.

(3) Anonymous Spectator:

An Anonymous Spectator has limited access to game data of all Participants. Can view general standings of all Participants, including handicap values, some narrative details (e.g., puzzles), and streaming data.

(4) Authenticated Spectator:

An Authenticated Spectator has access to all data an Anonymous Spectator can access, plus enhanced views of narrative and Participant status. For example, they may be able to view the precise location of any SP or Participant.

(5) Administrator:

Administrators have access to all of the data viewable by other levels, plus additional data sets such as enhanced handicap values of participants, state of the scenario or various puzzles and solutions. They may have the ability to modify the state of the narrative as the simulation occurs. Typically the only aspects of the simulation they cannot view or modify are associated with secure commerce aspects or private notes of the Participants. One skilled in the art will recognize that many other spectator definitions with different or similar access rights may be defined.

With the use of a commerce-enabled environment, spectators can indirectly participate in the simulation in a manner that enhances the simulation environment, while providing a source of income to the non-profit or profit-based recipient of the funds. A further description of a charity example use as an example commerce scenario is included in Appendix C, which is herein incorporated by reference in its entirety. In another example, spectators place (and pay for) wagers on simulation participants (e.g., game players) or others aspects of the underlying simulation scenario and the proceeds are distributed accordingly.

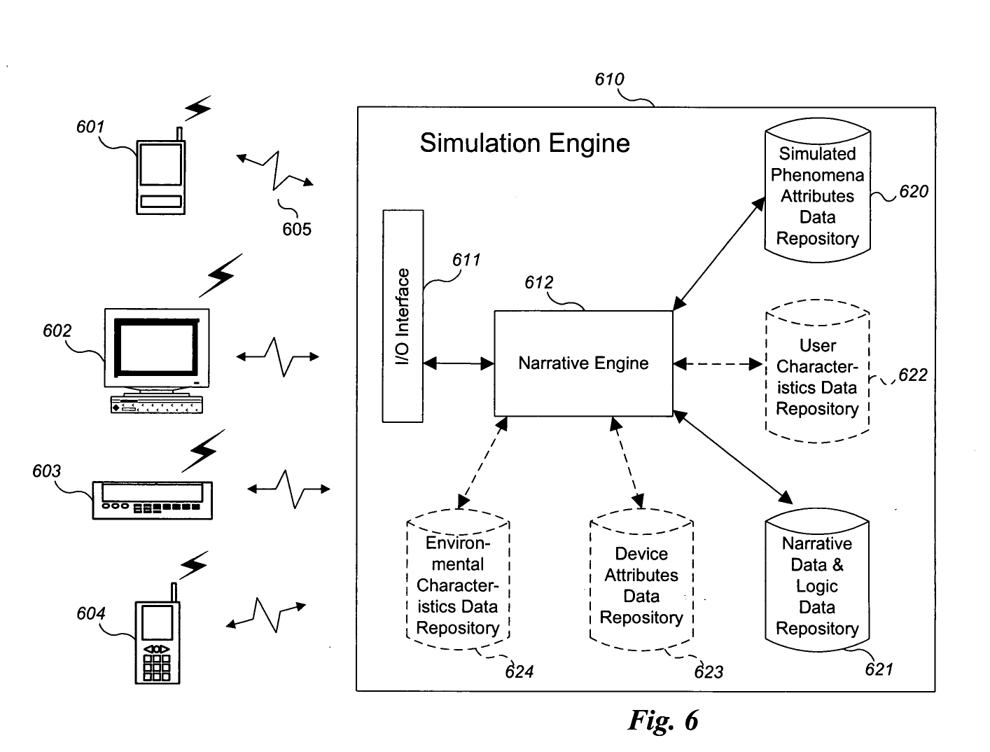

For use in all such simulation environments, a Simulated Phenomena Interaction System comprises a mobile device or other mobile computing environment and a simulation engine. FIG. 6 is an example block diagram of components of an example Simulated Phenomena Interaction System. In FIG. 6, a Simulated Phenomena Interaction System comprises one or more mobile devices or computing environments 601-604 and a simulation engine 610. For example, FIG. 6 shows four different types of mobile devices: a global positioning system (GPS) 601, a portable computing environment 602, a personal data assistant (PDA) 603, and a mobile telephone (e.g., a cell phone) 604. The mobile device is typically used by an operator as described above to indicate interaction requests with a simulated phenomenon. Simulation engine 610 responds to such indicated requests by determining whether the indicated interaction request is permissible and performing the interaction request if deemed so.

The simulation engine may further comprise a narrative with data and event logic, a simulated phenomena characterizations data repository, and a narrative engine (e.g., to implement a state machine for the simulation). The narrative engine uses the narrative and the simulated phenomena characterizations data repository to determine whether an indicated interaction is permissible, and, if so, to perform that interaction with a simulated phenomenon. In addition, the simulation engine may comprise other data repositories or store other data that characterizes the state of the mobile device, information about the operator, the state of the narrative, etc.

Accordingly, the simulation engine 610 may comprise a number of other components for processing interaction requests and for implementing the characterizations and behavior of simulated phenomena. For example, simulation engine 610 may comprise a narrative engine 612, an input/output interface 611 for interacting with the mobile devices 601-604 and for presenting a standardized interface to control the narrative engine and/or data repositories, and one or more data repositories 620-624. In what might be considered a more minimally configured simulation engine 610, the narrative engine 612 interacts with a simulated phenomena attributes data repository 620 and a narrative data and logic data repository 621. The simulated phenomena attributes data repository 620 typically stores information that is used to characterize and implement the “behavior” of simulated phenomena (responses to interaction requests). For example, attributes may include values for location, orientation, velocity, direction, acceleration, path, size, duration schedule, type, elasticity, mood, temperament, image, ancestry, or any other seemingly real world or imaginary characteristic of simulated phenomena. The narrative data and logic data repository 621 stores narrative information and event logic which is used to determine a next logical response to an interaction request. The narrative engine 612 uses the narrative data and logic data repository 621 and the simulated phenomena attributes data repository 620 to determine whether an indicated interaction is permissible, and, if so, to perform that interaction with the simulated phenomena. The narrative engine 612 then communicates a response or the result of the interaction to a mobile device, such as devices 601-604 through the I/O interface 611. I/O interface 611 may contain, for example support tools and protocol for interacting with a wireless device over a wireless network.

In a less minimal configuration, the simulation engine 610 may also include one or more other data repositories 622-624 for use with different configurations of the narrative engine 612. These repositories may include, for example, a user characteristics data repository 622, which stores characterizations of each user who is interacting with the system; a environment characteristics data repository 624, which stores values sensed by sensors within the real world environment; and a device attributes data repository 623, which may be used to track the state of each mobile device being used to interact with the SPs.

One skilled in the art will recognize that many different ways are available to determine or calculate values for the attributes stored in these repositories, including, for example, determining a pre-defined constant value; evaluating a mathematical formula, including a value that is based upon the values of other attributes; human input; real-world data sampling; etc. In addition, the same or different determination techniques may be used for each of the different types of data repositories (e.g., simulated phenomena, device, user, environment, etc.), varied on a per attribute basis, per device, per SP, etc. Many other arrangements are possible and contemplated.

One skilled in the art will recognize that many configurations are possible with respect to the narrative engine 612 and the various data repositories 620-624. These configurations may vary with respect to how much logic and data is contained in the narrative engine 612 itself versus stored in each data repository and whether the event logic (e.g., in the form of a narrative state machine) is stored in data repositories, as for example stored procedures, or is stored in other (not shown) code modules or as mathematical function definitions. In the embodiment exemplified in FIG. 6, it is assumed that the logic for representing and processing the simulated phenomena and the narratives are contained in the respective data repositories 620 and 621 themselves. In an alternate embodiment, there may be additional modules in the simulation engine that model the various subcomponents of the SPIS.

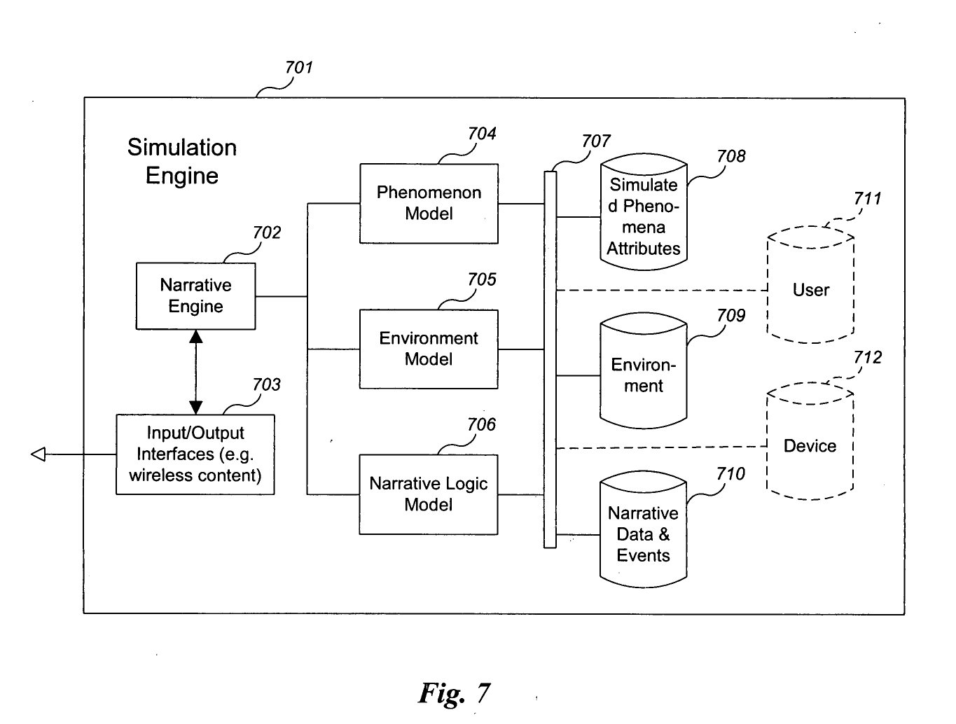

FIG. 7 is an example block diagram of an alternative embodiment of components of an example simulation engine. In this embodiment, separate modules implement the logic needed to model each component of a simulation engine, such as the simulated phenomena, the environment, and the narrative. As in the embodiment described in FIG. 6, the simulation engine 701 comprises a narrative engine 702, input/output interfaces 703, and one or more data repositories 708-712. Also, similarly, the narrative engine 702 receives and responds to interaction requests through the input/output interfaces 703. I/O interfaces 703 may contain, for example, support tools and protocol for interacting with a wireless device over a wireless network. In addition, however, simulation engine 701 contains separate models for interacting with the various data repositories 708-712. For example, simulation engine 701 comprises a phenomenon model 704, a narrative logic model 706, and an environment model 705. The data repositories 708-712 are shown connected to a data repository “bus” 707 although this bus may be merely an abstraction. Bus 707 is meant to signify that any of the models 704-706 may be communicating with one or more of the data repositories 708-712 resident on the bus 707 at any time. In this embodiment, as in the embodiment shown in FIG. 6, some of the data repositories 708-712 are shown as optional (dotted lines), such as a user characteristics data repository 711 and a device attributes data repository 712. However, because FIG. 7 shows an example that uses an environment model 705, FIG. 7 shows a corresponding environment data repository 709, which stores the state (real or otherwise) of various attributes being tracked in the environment.

Models 704-706 are used to implement the logic (that affects event flow and attribute values) that governs the various entities being manipulated by the system, instead of placing all of the logic into the narrative engine 702, for example. Distributing the logic into separate models allows for more complex modeling of the various entities manipulated by the simulation engine 701, such as, for example, the simulated phenomena, the narrative, and representations of the environment, users, and devices. For example, a module or subcomponent that models the simulated phenomena, the phenomenon model 704, is shown separately connected to the plurality of data repositories 708-712. This allows separate modeling of the same type of SP, depending, for example, on the mobile device, the user, the experience of the user, sensed real world environment values for a specific device, etc. Having a separate phenomenon model 704 also allows easy testing of the environment to implement, for example, new scenarios by simply replacing the relevant modeling components. It also allows complex modeling behaviors to be implemented more easily, such as SP attributes whose values require a significant amount of computing resources to calculate; new behaviors to be dynamically added to the system (perhaps, even, on a random basis); multi-user interaction behavior (similar to a transaction processing system that coordinates between multiple users interacting with the same SP); algorithms, such as artificial intelligence: based algorithms, which are better executed on a distributed server machine; or other complex requirements.

Also, for example, the environment model 705 is shown separately connected to the plurality of data repositories 708-712. Environment model 705 may comprise state and logic that dictates how attribute values that are sensed from the environment influence the simulation engine responses. For example, the type of device requesting the interaction, the user associated with the current interaction request, or some such state may potentially influences how a sensed environment value affects an interaction response or an attribute value of an SP.

Similarly, the narrative logic model 706 is shown separately connected to the plurality of data repositories 708-712. The narrative logic model 706 may comprise narrative logic that determines the next event in the narrative but may vary the response from user to user, device to device, etc., as well as based upon the particular simulated phenomenon being interacted with.

The content of the data repositories and the logic necessary to model the various aspects of the system essentially defines each possible narrative, and hence it is beneficial to have an easy method for tailoring the SPIS for a specific scenario. In one embodiment, the various data repositories and/or the models are populated using an authoring system.

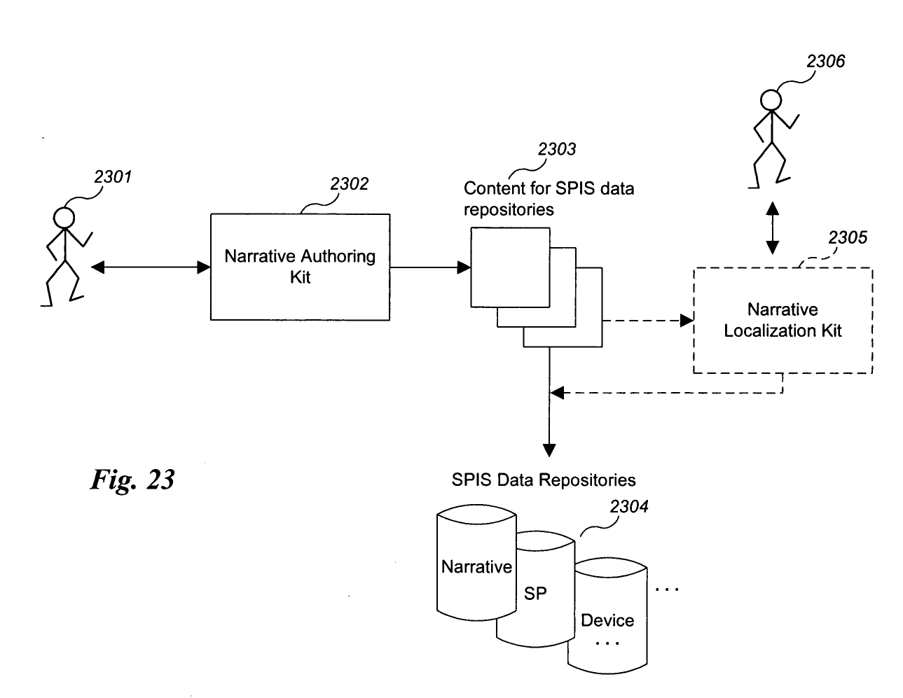

FIG. 23 is an example block diagram of an authoring system used with the Simulated Phenomena Interaction System. In FIG. 23, a narrative author 2301 invokes a narrative authoring toolkit (“kit”) 2302 to generate data repository content 2303 for each of the data repositories 2304 to be populated. The narrative authoring kit 2302 provides tools and procedures necessary to generate the content needed for the data respository. The generated content 2303 is then stored in the appropriate SPIS data repositories 2304. (For example, SP content is stored in the appropriate Simulated Phenomena Attributes data repository, such as repository 620 in FIG. 6.) In some circumstances, it is desirable to localize the SPIS data repository content by customizing a generic narrative scenario to a particular location, for example, by adding environment-specific data values to the narrative data. In such circumstances, the data repository content is optionally forwarded to a narrative localization kit 2305 prior to being stored in the appropriate Simulated Phenomena Attributes data repositories 2304. A localization person 2306 uses the localization kit 2305 to facilitate collecting, determining, organizing, and integrating environment-specific data into the SPIS data repositories 2304.

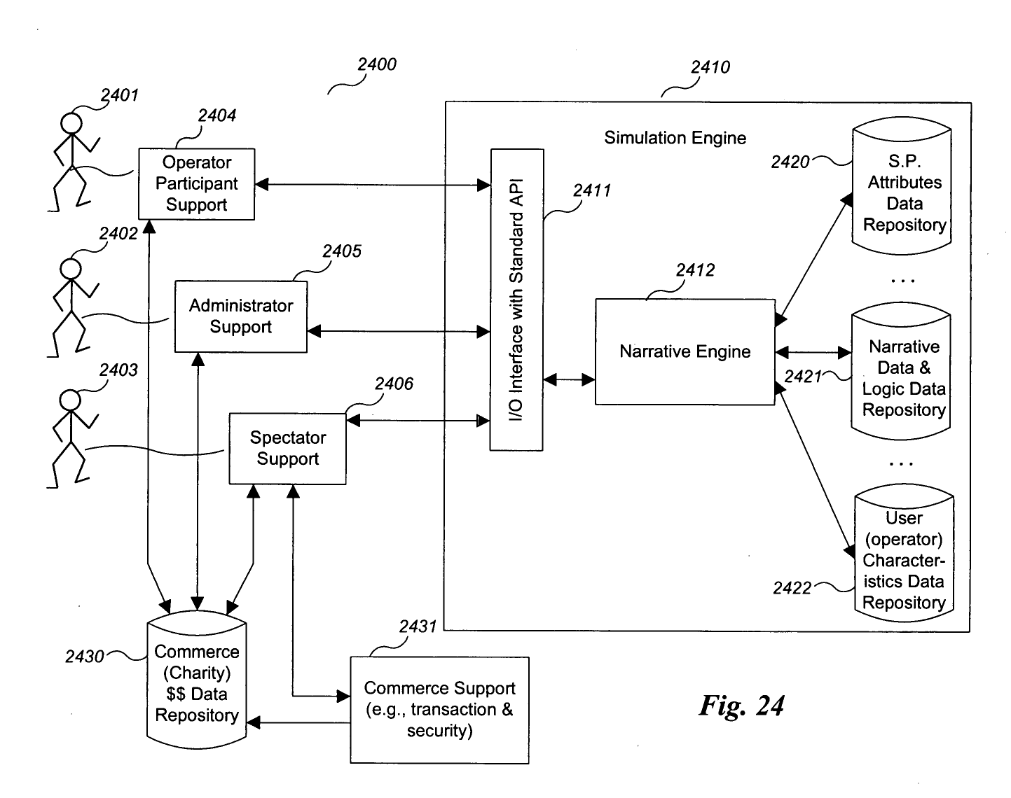

When a Simulated Phenomena Interaction System is integrated into a commerce-enabled scenario, additional components are present to handle commerce transactions and interfacing to the various other “participants” of the simulation scenario, for example, spectators, game administrators, contagion experts, etc. FIG. 24 is an example block diagram of an example Simulated Phenomena Interaction System integrated into components of a commerce-enabled environment. The commerce-enabled environment shown in FIG. 24 depicts the use of a SPIS scenario with a charity based commerce system. One skilled in the art will recognize that other commerce-enabled uses are also contemplated and integrated with the SPIS in a similar fashion. For example, a commerce-enabled environment that supports wagers placed on mobile device gaming participants or simulated phenomena of an underlying game is also supported by the modules depicted in FIG. 24.

In FIG. 24, commerce system 2400 comprises SPIS support modules 2404-2406, commerce transaction support 2431, a commerce data repository 2430, and simulation engine 2410. Users (commerce participants) 2401-2403, through the SPIS support modules 2404-2406, interact with the SPIS system as described relative to FIGS. 6 and 7 through the input/output interface 2411, which also contains a standardized interface (application programming interface known as an “API”) for interfacing to the. SPIS simulation engine 2410. For example, mobile operator (participant) 2401 uses the operator participant support module 2404 to interact with the simulation engine 2412. Similarly administrator 2402 uses the administrator support module 2405 to manage various aspects of the underlying simulation scenario such as defining the various charitable donations required for different types of operator assistance. Also similarly, spectator 2403 uses the spectator support module 2406 to view simulation environment and competitors' parameters and to engage in a financial transaction (such as a charity donation) via commerce support module 2431.

For example, after viewing the progress of the underlying simulation scenario via spectator support module 2406, the spectator 2403 may choose to support a team the spectator 2403 desires will win. (In a commerce-enable wagering environment, the spectator 2403 may choose to place “bets” on a team, a device operator, or, for example, a simulated phenomenon that the spectator 2403 believes will win.) Accordingly, spectator 2403 “orders” an assist via spectator support module 2406 by paying for it via commerce support module 2431. Once a financial transaction has been authenticated and verified (using well-known transaction processing systems such as credit card servers on the Internet), appropriate identifying data is placed by the commerce support module 2431 into the commerce data repository 2430 where it can be retrieved by the various SPIS support modules 2404-2406. The spectator support module then informs the simulation engine 2410 of the donation and instructs the simulation engine 2410 to provide assistance (for example, through a hint to the designated mobile device operator) or other activity.

In some scenarios, a spectator 2403 may be permitted to modify certain simulation data stored in the data repositories 2420-2422. Such capabilities are determined by the capabilities offered through the API 2411, the narrative, and the manner in which the data is stored.

In one arrangement, the SPIS support modules 2404-2406 interface with the SPIS data repositories 2420-2422 via the narrative engine 2412. One skilled in the art will recognize that rather than interface through the narrative engine 2412, other embodiments are possible that interface directly through data repositories 2420-2422. Example SPIS data repositories that can be viewed and potentially manipulated by the different participants 2401-2403 include the simulated phenomena attributes data repository 2420, the narrative data & logic data repository 2421, and the user (operator) characteristics data repository 2422. Other SPIS data repositories, although not shown, may be similarly integrated.

In some scenarios, a spectator is permitted to place wagers on particular device operators, teams, or simulated phenomena. Further, in response to such wagers, the narrative may influence aspects of the underlying simulation scenario. In such cases the commerce support 2431 includes well-known wager-related support services as well as general commerce transaction support. One skilled in the art will recognize that the possibilities abound and that that modules depicted in FIG. 24 can support a variety of commerce-enabled environments.

Regardless of the internal configurations of the simulation engine, the components of the Simulated Phenomena Interaction System process interaction requests in a similar overall functional manner.

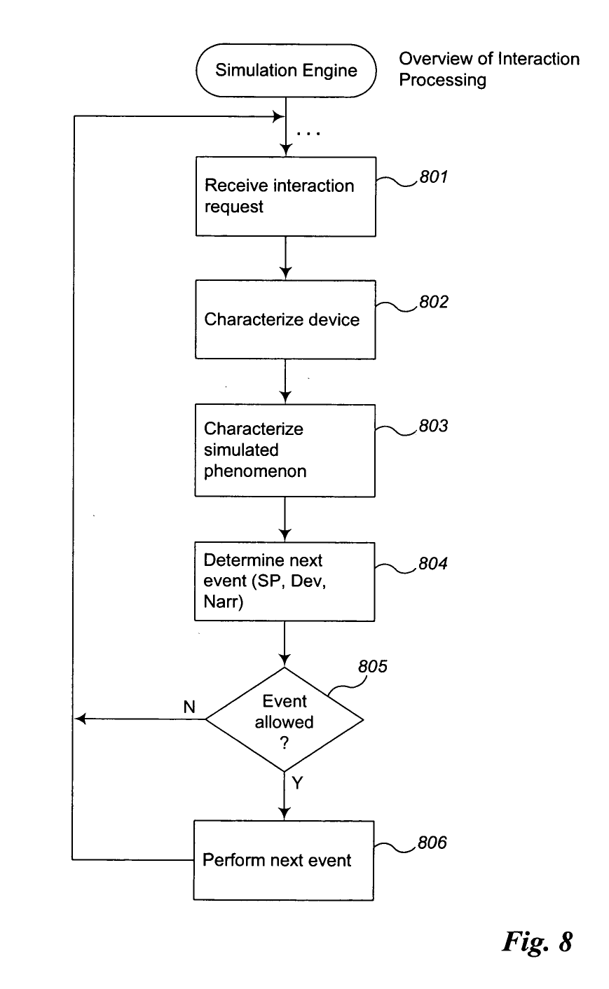

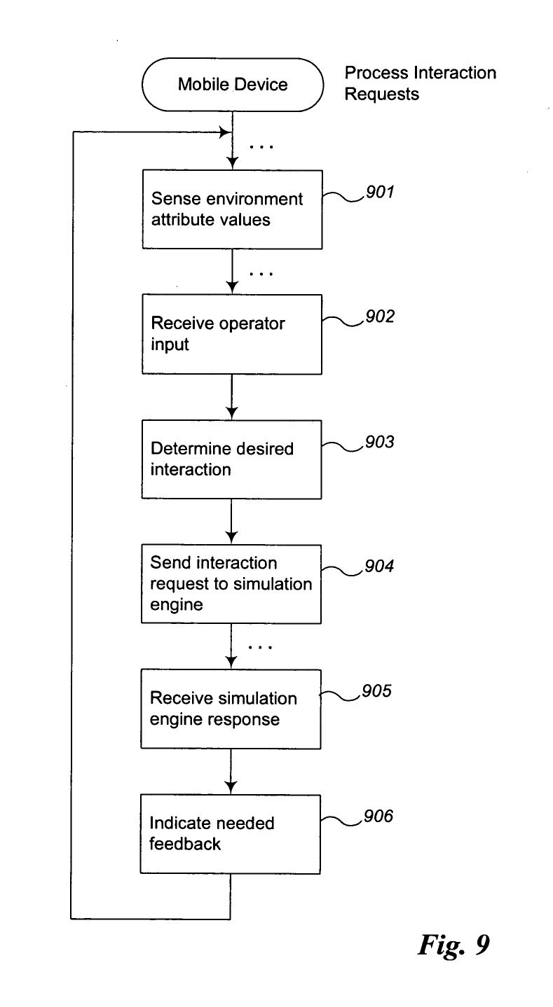

FIGS. 8 and 9 provide overviews of the interaction processing of a simulation engine and a mobile device in a Simulated Phenomena Interaction System. FIG. 8 is an overview flow diagram of example steps to process interaction requests within a simulation engine of a Simulated Phenomena Interaction System. In step 801, the simulation engine receives an interaction request from a mobile device. In step 802, the simulation engine characterizes the device from which the request was received, and, in step 803, characterizes the simulated phenomenon that is the target/destination of the interaction request. Using such characterizations, the simulation engine is able to determine whether or not, for example, a particular simulated phenomenon may be interacted with by the particular device. In step 804, the simulation engine determines, based upon the device characterization, the simulated phenomenon characterization, and the narrative logic the next event in the narrative sequence; that is, the next interaction response or update to the “state” or attributes of some entity in the SPIS. In step 805, if the simulation engine determines that the event is allowed (based upon the characterizations determined in steps 802-804), then the engine continues in step 806 to perform that event (interaction response), or else continues back to the beginning of the loop in step 801 to wait for the next interaction request.

FIG. 9 is an overview flow diagram of example steps to process interactions within a mobile device used with a Simulated Phenomena Interaction System. In step 901, optionally within some period of time, and perhaps not with each request or not at all, the device senses values based upon the real world environment in which the mobile device is operating. As described earlier, this sensing of the real world may occur by a remote sensor that is completely distinct from the mobile device, attached to the mobile device, or may occur as an integral part of the mobile device. For example, a remote sensor may be present in an object in the real world that has no physical connection to the mobile device at all. One skilled in the art will recognize that many types of values may be sensed by such mobile devices and incorporated within embodiments of the SPIS including, for example, sensing values associated with ambient light, temperature, heart rate, proximity of objects, barometric pressure, magnetic fields, traffic density, etc. In step 902, the device receives operator input, and in step 903 determines the type of interaction desired by the operator. In step 904, the device sends a corresponding interaction request to the simulation engine and then awaits a response from the simulation engine. One skilled in the art, will recognize that depending upon the architecture used to implement the SPIS, the sending of an interaction request may be within the same device or may be to a remote system. In step 905, a simulation engine response is received, and in step 906, any feedback indicated by the received response is indicated to the operator. The mobile device processing then returns to the beginning of the loop in step 901.

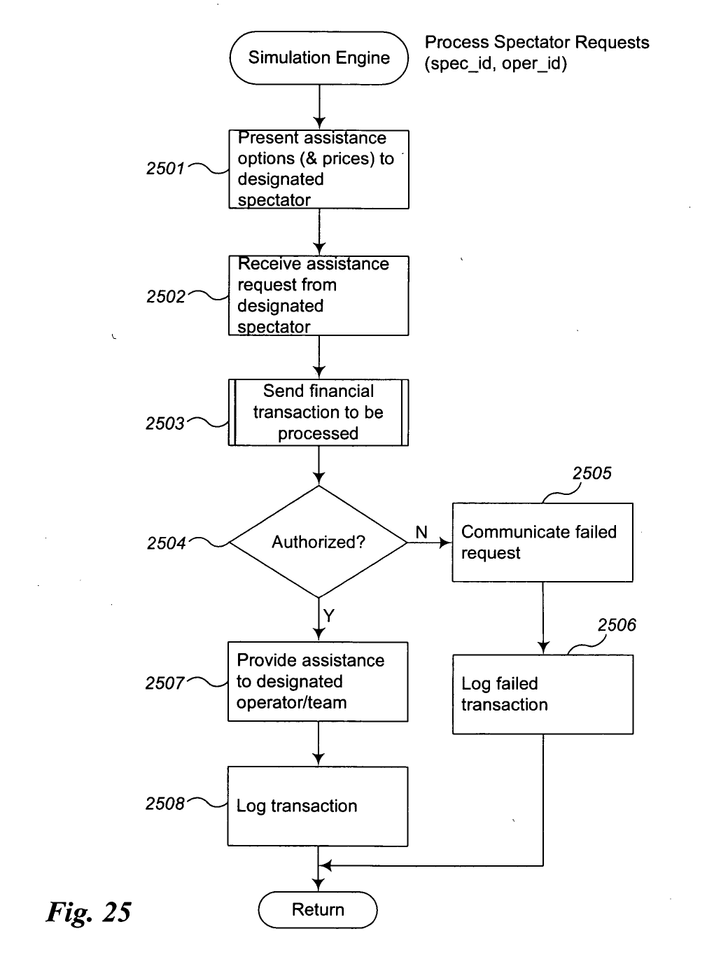

When the simulation engine is used in a commerce-enabled environment, such as that shown in FIG. 24, the simulation engine needs also to process interface requests and respond to simulation participants, such as administrators and spectators, other than the operators of mobile devices. FIG. 25 is an overview flow diagram of example steps to process spectator requests within a simulation engine of a Simulated Phenomena Interaction System. In step 2501, the simulation engine presents options to the designated spectator. In one scenario, the prices may vary according to the kind of assistance or manipulation requested or wager and the success status of a designated operator participant. For example, if the designated operator participant is a winning team, the price for spectator participation may be increased. In step 2502, the simulation engine receives a request (from a designated spectator) to assist the designated recipient. In step 2503, the simulation engine invokes a standard financial transaction system to process the financial aspects of the request. In step 2504 if the transaction is properly authorized, then the engine continues in step 2507, otherwise continues in step 2505. In step 2505, the engine indicates a failed request to the user, logs the failed financial transaction in steps 2506, and returns. In step 2507, the simulation engine provides the indicated assistance (or other indicated participation) to the designated operator or team, logs the successful transaction in step 2508, and returns.

Although the techniques of Simulated Phenomena Interaction System are generally applicable to any type of entity, circumstance, or event that can be modeled to incorporate a real world attribute value, the phrase “simulated phenomenon,” is used generally to imply any type of imaginary or real-world place, person, entity, circumstance, event, occurrence. In addition, one skilled in the art will recognize that the phrase “real-world” means in the physical environment or something observable as existing, whether directly or indirectly. Also, although the examples described herein often refer to an operator or user, one skilled in the art will recognize that the techniques of the present invention can also be used by any entity capable of interacting with a mobile environment, including a computer system or other automated or robotic device. In addition, the concepts and techniques described are applicable to other mobile devices and other means of communication other than wireless communications, including other types of phones, personal digital assistances, portable computers, infrared devices, etc, whether they exist today or have yet to be developed. Essentially, the concepts and techniques described are applicable to any mobile environment. Also, although certain terms are used primarily herein, one skilled in the art will recognize that other terms could be used interchangeably to yield equivalent embodiments and examples. In addition, terms may have alternate spellings which may or may not be explicitly mentioned, and one skilled in the art will recognize that all such variations of terms are intended to be included.

Example embodiments described herein provide applications, tools, data structures and other support to implement a Simulated Phenomena Interaction System to be used for games, interactive guides, hands-on training environments, and commerce-enabled simulation scenarios. One skilled in the art will recognize that other embodiments of the methods and systems of the present invention may be used for other purposes, including, for example, traveling guides, emergency protocol evaluation, and for more fanciful purposes including, for example, a matchmaker (SP makes introductions between people in a public place), traveling companions (e.g., a bus “buddy” that presents SPs to interact with to make an otherwise boring ride potentially more engaging), a driving pace coach (SP recommends what speed to attempt to maintain to optimize travel in current traffic flows), a wardrobe advisor (personal dog robot has SP “personality,” which accesses current and predicted weather conditions and suggests attire), etc. In the following description, numerous specific details are set forth, such as data formats and code sequences, etc., in order to provide a thorough understanding of the techniques of the methods and systems of the present invention. One skilled in the art will recognize, however, that the present invention also can be practiced without some of the specific details described herein, or with other specific details, such as changes with respect to the ordering of the code flow.

A variety of hardware and software configurations may be used to implement a Simulated Phenomena Interaction System. A typical configuration, as illustrated with respect to FIGS. 2 and 6, involves a client-server architecture of some nature. One skilled in the art will recognize that many such configurations exist ranging from a very thin client (mobile) architecture that communicates with all other parts of the SPIS remotely to a fat client (mobile) architecture that incorporates all portions of the SPIS on the client device. Many configurations in between these extremes are also plausible and expected.

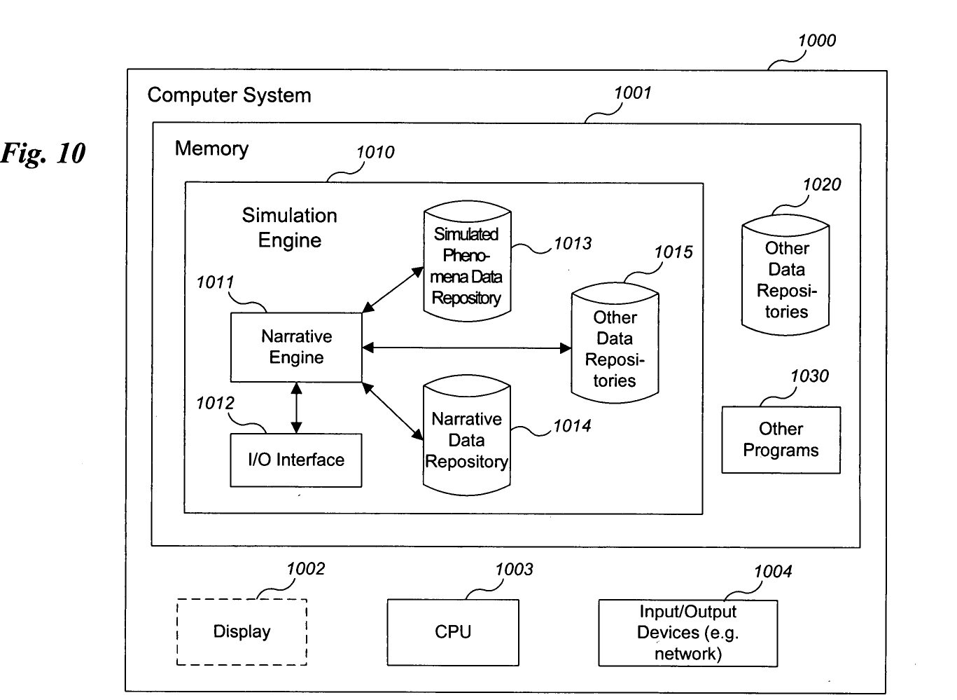

FIG. 10 is an example block diagram of a general purpose computer system for practicing embodiments of a simulation engine of a Simulated Phenomena Interaction System. The general purpose computer system 1000 may comprise one or more server (and/or client) computing systems and may span distributed locations. In addition, each block shown may represent one or more such blocks as appropriate to a specific embodiment or may be combined with other blocks. Moreover, the various blocks of the simulation engine 1010 may physically reside on one or more machines, which use standard interprocess communication mechanisms, across wired or wireless networks to communicate with each other.

In the embodiment shown, computer system 1000 comprises a computer memory (“memory”) 1001, an optional display 1002, a Central Processing Unit (“CPU”) 1003, and Input/Output devices 1004. The simulation engine 1010 of the Simulated Phenomena Interaction System (“SPIS”) is shown residing in the memory 1001. The components of the simulation engine 1010 preferably execute on CPU 1003 and manage the generation and interaction with of simulated phenomena, as described in previous figures. Other downloaded code 1030 and potentially other data repositories 1030 also reside in the memory 1010, and preferably execute on one or more CPU's 1003. In a typical embodiment, the simulation engine 1010 includes a narrative engine 1011, an I/O interface 1012, and one or more data repositories, including simulated phenomena attributes data repository 1013, narrative data and logic data repository 1014, and other data repositories 1015. In embodiments that include separate modeling components, these components would additionally reside in the memory 1001 and execute on the CPU 1003.

In an example embodiment, components of the simulation engine 1010 are implemented using standard programming techniques. One skilled in the art will recognize that the components lend themselves object-oriented, distributed programming, since the values of the attributes and behavior of simulated phenomena can be individualized and parameterized to account for each device, each user, real world sensed values, etc. However, any of the simulation engine components 1011-1015 may be implemented using more monolithic programming techniques as well. In addition, programming interfaces to the data stored as part of the simulation engine 1010 can be available by standard means such as through C, C++, C#, and Java API and through scripting languages such as XML, or through web servers supporting such interfaces. The data repositories 1013-1015 are preferably implemented for scalability reasons as databases rather than as a text file, however any storage method for storing such information may be used. In addition, behaviors of simulated phenomena may be implemented as stored procedures, or methods attached to SP “objects,” although other techniques are equally effective.

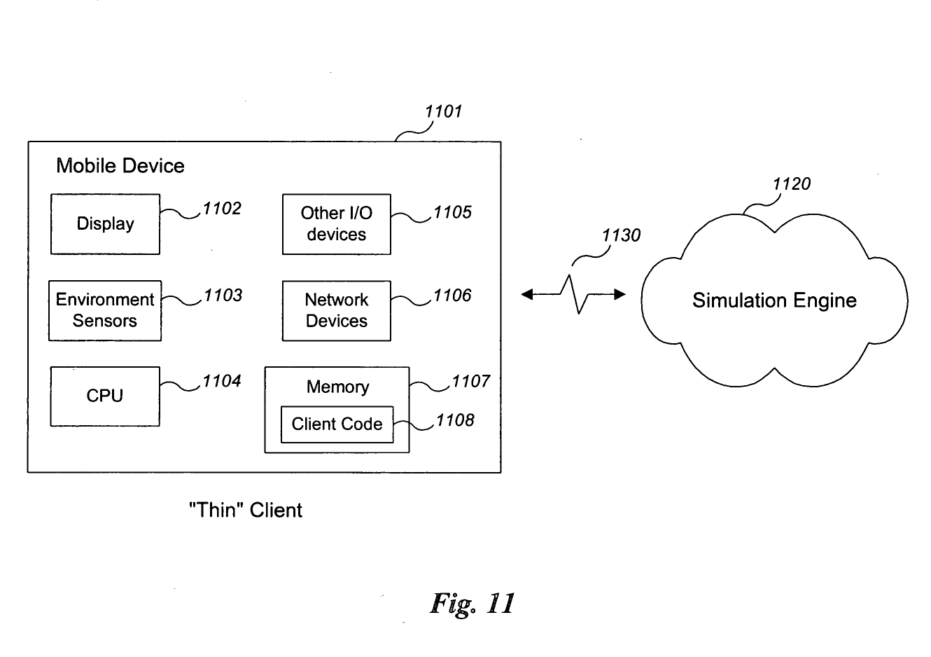

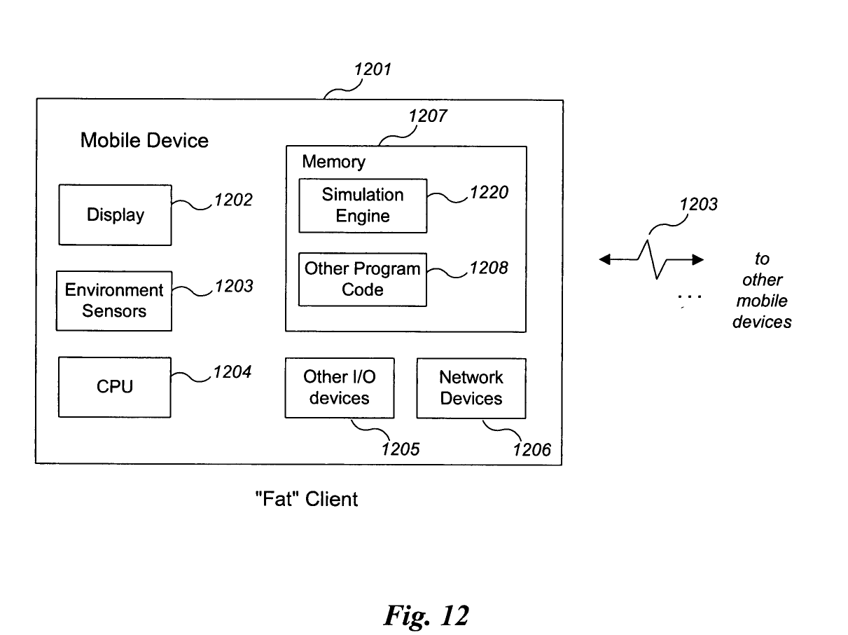

One skilled in the art will recognize that the simulation engine 1010 and the SPIS may be implemented in a distributed environment that is comprised of multiple, even heterogeneous, computer systems and networks. For example, in one embodiment, the narrative engine 1011, the I/O interface 1012, and each data repository 1013-1015 are all located in physically different computer systems, some of which may be on a client mobile device as described with reference to FIGS. 11 and 12. In another embodiment, various components of the simulation engine 1010 are hosted each on a separate server machine and may be remotely located from tables stored in the data repositories 1013-1015.

FIGS. 11 and 12 are examples block diagrams of client devices used for practicing embodiments of the simulated phenomena interaction system.

FIG. 11 illustrates an embodiment of a “thin” client mobile device, which interacts with a remote simulation engine running for example on a general purpose computer system, as shown in FIG. 10. FIG. 12 illustrates an embodiment of a “fat” client mobile device in which one or more portions of the simulation engine reside as part of the mobile device environment itself.

Specifically, FIG. 11 shows mobile device 1101 interacting over a mobile network 1130, such as a wireless network 1130, to interact with simulation engine 1120. The mobile device 1101 may comprise a display 1102, a CPU 1104, a memory 1107, one or more environment sensors 1103, one or more network devices 1106 for communicating with the simulation engine 1120 over the network 1130, and other input/output devices 1105. Code such as client code 1108 that is needed to interact with the simulation engine 1120 preferably resides in the memory 1108 and executes on the CPU 1104. One skilled in the art will recognize that a variety of mobile devices may be used with the SPIS included cell phones, PDAs, GPSes, portable computing devices, infrared devices, 3-D wireless (e.g., headmounted) glasses, virtual reality devices, other handheld devices and wearable devices, and basically any mobile or portable device capable of location sensing. In addition, network communication may be provided over cell phone modems, IEEE 802.11b protocol, Bluetooth protocol or any other wireless communication protocol or equivalent.

Alternatively, the client device may be implemented as a fat client mobile device as shown in FIG. 12. In FIG. 12, mobile device 1201 is shown communicating via a communications network 1230 to other mobile device or portable computing environments. The communications network may be a wireless network or a wired network used to intermittently send data to other devices and environments. The mobile device 1201 may comprise a display 1202, a CPU 1204, a memory 1207, one or more environment sensors 1203, one or more network devices 1206 for communicating over the network 1230, and other input/output devices 1205. The components 1202-1206 correspond to their counterparts described with reference to the thin client mobile device illustrated in FIG. 12. As currently depicted, all components and data of the simulation engine 1220 are contained within the memory 1207 of the client device 1201 itself. However, one skilled in the art will recognize that one or more portions of simulation engine 1220 may be instead remotely located such that the mobile device 1201 communicates over the communications network 1230 using network devices 1206 to interact with those portions of the simulation engine 1220. In addition to a simulation engine 1220 shown in the memory 1207 is other program code 1208, which may be used by the mobile device to initiate an interaction request as well as for other purposes, some of which may be unrelated to the SPIS.

Different configurations and locations of programs and data are contemplated for use with the techniques of the present invention. In example embodiments, these components may execute concurrently and asynchronously; thus, the components may communicate using well-known message passing techniques. One skilled in the art will recognize that equivalent synchronous embodiments are also supported by an SPIS implementation, especially in the case of a fat client architecture. Also, other steps could be implemented for each routine, and in different orders, and in different routines, yet still achieve the functions of the SPIS.

As described in FIGS. 1-9, some of the primary functions of a simulation engine of a Simulated Phenomena Interaction System are to implement (generate and manage) simulated phenomena and to handle interaction requests from mobile devices so as to incorporate simulated phenomena into the real world environments of users.

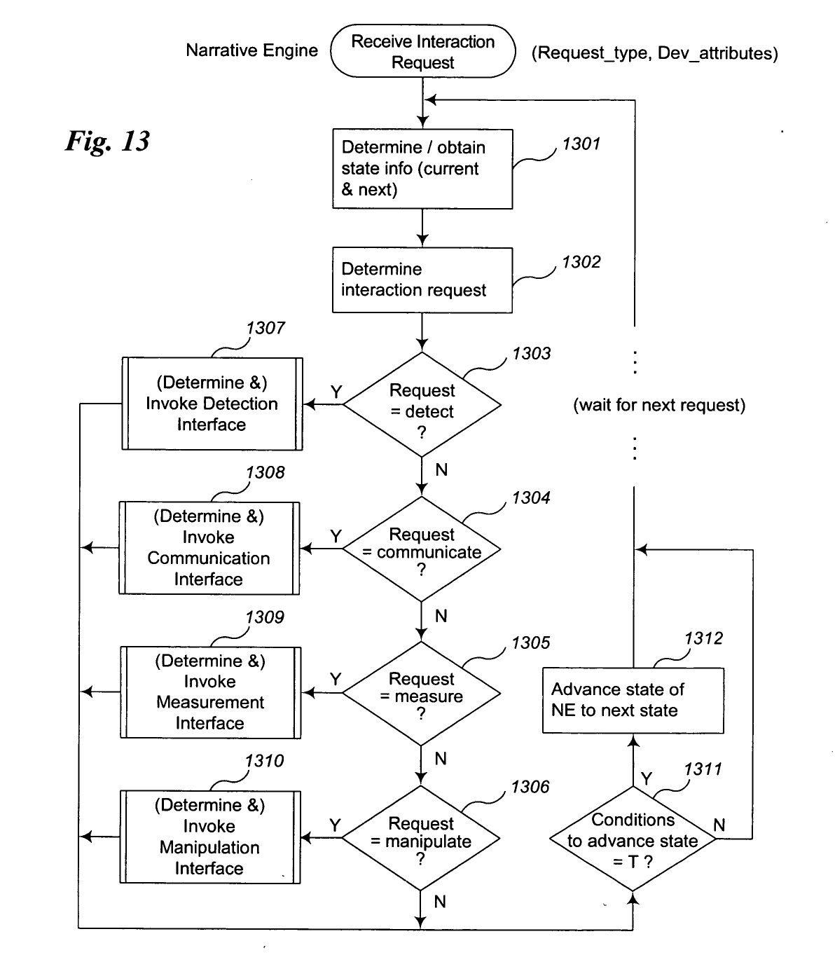

FIG. 13 is an example block diagram of an event loop for an example simulation engine of a Simulated Phenomena Interaction System. As described earlier, typically the narrative engine portion of the simulation engine receives interaction requests from a mobile device through the I/O interfaces, determines how to process them, processes the requests if applicable, and returns any feedback indicated to the mobile device for playback or display to an operator. The narrative engine receives as input with each interaction request an indication of the request type and information that identifies the device or specify attribute values from the device. Specifically, in step 1301, the narrative engine determines or obtains state information with respect to the current state of the narrative and the next expected possible states of the narrative. That is, the narrative engine determines what actions and/or conditions are necessary to advance to the next state and how that state is characterized. This can determined by any standard well-known means for implementing a state machine, such as a case statement in code, a table-driven method etc. In step 1302, the narrative engine determines what type of interaction request was designated as input and in steps 1303-1310 processes the request accordingly. More specifically, in step 1303, if the designated interaction request corresponds to a detection request, then the narrative engine proceeds in step 1307 to determine which detection interface to invoke and then invokes the determined interface. Otherwise, the narrative engine continues in step 1304 to determine whether the designated interaction request corresponds to a communications interaction request. If so, the narrative engine continues in step 1308, to determine which communication interface to invoke and subsequently invokes the determined interface. Otherwise, the narrative engine continues in step 1305 to determine whether the designated interaction request corresponds to a measurement request. If so, then the narrative engine continues in step 1309 to determine which measurement interface to invoke and then invokes the determined interface. Otherwise, the narrative engine continues in step 1306 to determine whether the designated interaction request corresponds to a manipulation request. If so, the narrative engine continues in step 1310 to determine which manipulation interface to invoke and then invokes the determined interface. Otherwise, the designated interaction request is unknown, and the narrative engine continues in step 1311. (The narrative engine may invoke some other default behavior when an unknown interaction request is designated.) In step 1311, the narrative engine determines whether the previously determined conditions required to advance the narrative to the next state have been satisfied. If so, the narrative engine continues in step 1312 to advance the state of the narrative engine to the next state indicated by the matched conditions, otherwise continues to wait for the next interaction request. Once the narrative state has been advanced, the narrative engine returns to the beginning of the event loop in step 1301 to wait for the next interaction request.

As indicated in FIG. 13, the narrative engine needs to determine which interaction routine to invoke (steps 1307-1310). One skilled in the art will recognize that any of the interaction routines including a detection routine can be specific to a simulated phenomenon, a device, an environment, or some combination of any such factors or similar factors. Also, depending upon the architecture of the system, the overall detection routine (which calls specific detection functions) may be part of the narrative engine, a model, or stored in one of the data repositories.

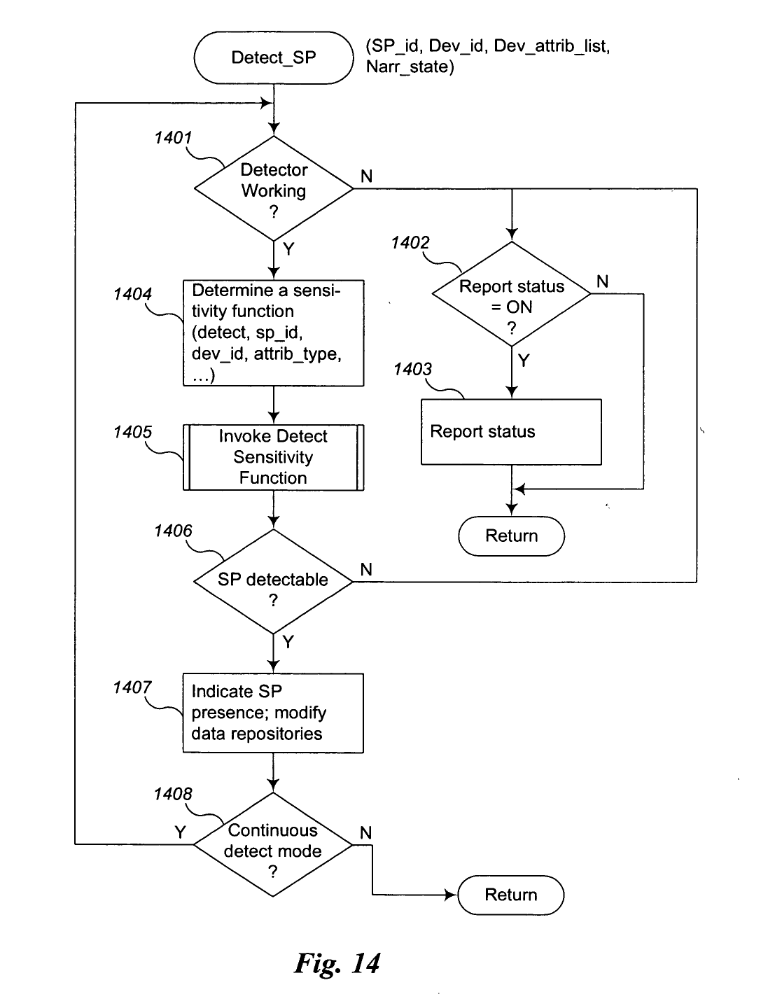

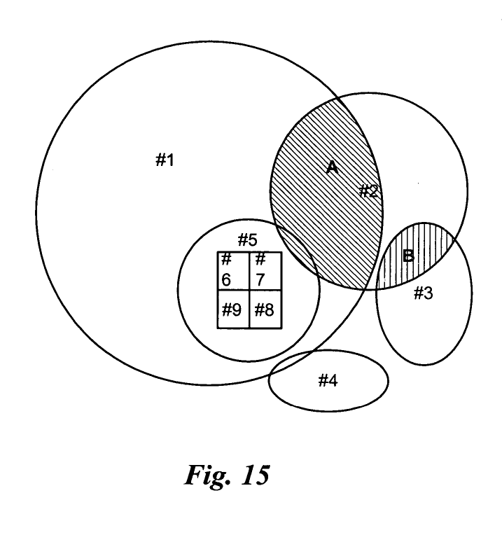

FIG. 14 is an example flow diagram of an example detection interaction routine provided by a simulation engine of a Simulated Phenomena Interaction System. This routine may reside and be executed by the narrative engine portion of the simulation engine. In the example shown in FIG. 14, the Detect_SP routine (the overall detection routine) includes as input parameters the factors needed to be considered for detection. In this example, the Detect_SP routine receives a designated identifier of the particular simulated phenomenon (SP_id), a designated identifier of the device (Dev_id), any designated number of attributes and values that correspond to the device (Dev_attrib_list), and the current narrative state information associated with the current narrative state (narr_state). The current narrative state information contains, for example, the information determined by the narrative engine in step 1301 of the Receive Interaction Request routine. The detection routine, as common to all the interaction routines, determines given the designed parameters whether the requested interaction is possible, invokes the interaction, and returns the results of the interaction or any other feedback so that it can be in turn reported to the mobile device via the narrative engine.

Specifically, in step 1401, the routine determines whether the detector is working, and, if so, continues in step 1404 else continues in step 1402. This determination is conducted from the point of view of the narrative, not the mobile device (the detector). In other words, although the mobile device may be working correctly, the narrative may dictate a state in which the client device (the detector) appears to be malfunctioning. In step 1402, the routine, because the detector is not working, determines whether the mobile device has designated or previously indicated in some manner that the reporting of status information is desirable. If so, the routine continues in step 1403 to report status information to the mobile device (via the narrative engine), and then returns. Otherwise, the routine simply returns without detection and without reporting information. In step 1404, when the detector is working, the routine determines whether a “sensitivity function” exists for the particular interaction routine based upon the designated SP identifier, device identifier, the type of attribute that the detection is detecting (the type of detection), and similar parameters.

A “sensitivity function” is the generic name for a routine, associated with the particular interaction requested, that determines whether an interaction can be performed and, in some embodiments, performs the interaction if it can be performed.

That is, a sensitivity function determines whether the device is sufficiently “sensitive” (in “range” or some other attribute value) to interact with the SP with regard specifically to the designated attribute in the manner requested. For example, there may exist many detection routines available to detect whether a particular SP should be considered “detected” relative to the current characteristics of the requesting mobile device. The detection routine that is eventually selected as the “sensitivity function” to invoke at that moment may be particular to the type of device, some other characteristic of the device, the simulated phenomena being interacted with, or another consideration, such as an attribute value sensed in the real world environment, here shown as “attrib_type.” For example, the mobile device may indicate the need to “detect” an SP based upon a proximity attribute, or an agitation attribute, or a “mood” attribute (an example of a completely arbitrary, imaginary attribute of an SP). The routine may determine which sensitivity function to use in a variety of ways. The sensitivity functions may be stored, for example, as a stored procedures in the simulated phenomena characterizations data repository, such as data repository 620 in FIG. 6, indexed by attribute type of an SP type. An example routine for finding a sensitivity function and an example sensitivity function are described below with reference to Tables 1 and 2.

Once the appropriate sensitivity function is determined, then the routine continues in step 1405 to invoke the determined detection sensitivity function. Then, in step 1406, the routine determines as a result of invoking the sensitivity function, whether the simulated phenomenon was considered detectable, and, if so, continues in step 1407, otherwise continues in step 1402 (to optionally report non-success). In step 1407, the routine indicates (in a manner that is dependent upon the particular SP or other characteristics of the routine) that the simulated phenomenon is present (detected) and modifies or updates any data repositories and state information as necessary to update the state of the SP, narrative, and potentially the simulated engine's internal representation of the mobile device, to consider the SP “detected.” In step 1408, the routine determines whether the mobile device has previously requested to be in a continuous detection mode, and, if so, continues in step 1401 to begin the detection loop again, otherwise returns.

One skilled in the art will recognize that other functionality can be added and is contemplated to be added to the detection routine and the other interaction routines. For example, functions for adjustment (real or imaginary) of the mobile device from the narrative's perspective and functions for logging information could be easily integrated into these routines.

TABLE 1

| | |
|---|---|
| 1 | function Sensitivity (interaction_type, dev_ID, SP_ID, |
| | att_typel, ..., att_typeN) |
| 2 | For each att_type |
| 3 | sensFunction = |
| | GetSensitivityFunctionForType(interaction_type, att_type) |
| 4 | If not sensFunction(SP_ID, dev_ID) |
| 5 | Return Not_Detectable |
| 6 | End for |
| 7 | Return Detectable |
| 8 | end function |

As mentioned, several different techniques can be used to determine which particular sensitivity function to invoke for a particular interaction request. Because, for example, there may be different sensitivity calculations based upon the type of interaction and the type of attribute to be interacted with. A separate sensitivity function may also exist on a per-attribute basis for the particular interaction on a per-simulated phenomenon basis (or additionally per device, per user, etc.). Table 1 shows the use of a single overall routine to retrieve multiple sensitivity functions for the particular simulated phenomenon and device combination, one for each attribute being interacted with. (Note that multiple attributes may be specified in the interaction request. Interaction may be a complex function of multiple attributes as well.) Thus, for example, if for a particular simulated phenomenon there are four attributes that need to be detected in order for the SP to be detected from the mobile device perspective, then there may be four separate sensitivity functions that are used to determine whether that attribute of the SP is detectable at that point. Note that, as shown in line 4, the overall routine can also include logic to invoke the sensitivity functions on the spot, as opposed to invoking the function as a separate step as shown in FIG. 14.

TABLE 2

```
SensitivityAgitation(SP_ID, dev_ID)
{
    Position positionDev, positionSP;
    long range, dist;
    int agitationSP;
    agitationSP = GetAgitationStateFromSP(SP_ID);
    positionSP = GetPositionOfSP(SP_ID);
    positionDev = GetPositionFromDevice(dev_ID);
    range = agitationSP * 10;
    dist = sqrt( (positionSP.x − positionDev.x)\hat{ }2 +
(positionSP.y − positionDev.y)\hat{ }2);
    if (dist <= range ) then
        return Detectable;
    else
        return Not_Detectable
}
```

Table 2 is an example sensitivity function that is returned by the routine GetSensitivityFunctionForType shown in Table 1 for a detection interaction for a particular simulated phenomenon and device pair as would be used with an agitation characteristic (attribute) of the simulated phenomenon. In essence, the sensitivity agitation function retrieves an agitation state variable value from the SP characterizations data repository, retrieves a current position from the SP characterization data repository, and receives a current position of the device from the device characterization data repository. The current position of the SP is typically an attribute of the SP, or calculated from such attribute. Further, it may be a function of the current actual location of the device. Note that the characteristics of the SP (e.g., the agitation state) are dependent upon which SP is being addressed by the interaction request, and may also be dependent upon the particular device interacting with the particular SP and/or the user that is interacting with the SP. Once the values are retrieved, the example sensitivity function then performs a set of calculations based upon these retrieved values to determine whether, based upon the actual location of the device relative to the programmed location of the SP, the SP agitation value is “within range.” If so, the function sends back a status of detectable; otherwise, it sends back a status of not detectable.

As mentioned earlier, the response to each interaction request is in some way based upon a real world physical characteristic, such as the physical location of the mobile device submitting the interaction request. The real world physical characteristic may be sent with the interaction request, sensed from a sensor in some other way or at some other time. Responses to interaction requests can also be based upon other real world physical characteristics, such as physical orientation of the mobile device—e.g., whether the device is pointing at a particular object or at another mobile device. One skilled in the art will recognize that many other characteristics can be incorporated in the modeling of the simulated phenomena, provided that the physical characteristics are measurable and taken into account by the narrative or models incorporated by the simulation engine. For the purposes of ease of description, a device's physical location will be used as exemplary of how a real world physical characteristic is incorporated in SPIS.

A mobile device, depending upon its type, is capable of sensing its location in a variety of ways, some of which are described here. One skilled in the art will recognize that there are many methods for sensing location and are contemplated for use with the SPIS. Once the location of the device is sensed, this location can in turn be used to model the behavior of the SP in response to the different interaction requests. For example, the position of the SP relative to the mobile device may be dictated by the narrative to be always a multiple from the current physical location of the user's device until the user enters a particular spot, a room, for example. Alternatively, an SP may “jump away” (exhibiting behavior similar to trying to swat a fly) each time the physical location of the mobile device is computed to “coincide” with the apparent location of the SP. To perform these type of behaviors, the simulation engine typically models both the apparent location of the SP and the physical location of the device based upon sensed information.

The location of the device may be an absolute location as available with some devices, or may be computed by the simulation engine (modeled) based upon methods like triangulation techniques, the device's ability to detect electromagnetic broadcasts, and software modeling techniques such as data structures and logic that models latitude, longitude, altitude, etc. Examples of devices that can be modeled in part based upon the device's ability to detect electromagnetic broadcasts include cell phones such as the Samsung SCH W300 with the Verizon™ network, the Motorola V710, which can operate using terrestrial electromagnetic broadcasts of cell phone networks or using the electromagnetic broadcasts of satellite GPS systems, and other “location aware” cell phones, wireless networking receivers, radio receivers, photo-detectors, radiation detectors, heat detectors, and magnetic orientation or flux detectors. Examples of devices that can be modeled in part based upon triangulation techniques include GPS devices, Loran devices, some E911 cell phones.

FIG. 15 is an example diagram illustrating simulation engine modeling of a mobile device that is able to sense its location by detecting electromagnetic broadcasts. For example, in some cases, a mobile device is able to “sense” when it can receive transmissions from a particular cell tower. More specifically, location is determined by the mobile device by performing triangulation calculations that measure the signal strengths of various local cell phone (fixed location) base stations. More commonly, a mobile device such as a cell phone receives location information transmitted to it by the base station based upon calculations carried out on the wireless network server systems. These server systems typically rely at least in part on the detected signal strength as measured by various base stations in the vicinity of the cell phone. The servers use triangulation and other calculations to determine the cell phone's location, which is then broadcast back to the phone, typically in a format that can be translated into longitude/latitude or other standard GIS data formats. This sensed information is then forwarded from the mobile device to the simulation engine-so that the simulation engine can model the position of the device (and subsequently the location of SPs). As a result of the modeling, the simulated engine might determine or be able to deduce that the device is currently situated in a particular real world area (region). Note that the regions may be continuous (detection flows from one region to another without an area where location in undetectable) or discontinuous (broadcast detection is interrupted by an area where transmissions cannot be received).

In the example shown in FIG. 15, each circle represents an physical area where the device is able to sense an electromagnetic signal from a transmitter, for example, a cell tower if the device is a cell phone. Thus, the circle labeled #1 represents a physical region where the mobile device is currently able to sense a signal from a first transmitter. The circle labeled #2 similarly represents a physical region where the mobile device is able to sense a signal from a second transmitter, etc. The narrative, hence the SP, can make use of this information in modeling the location of the SP relative to the mobile device's physical location. For example, when the mobile device demonstrates or indicates that it is in the intersection of the regions #1 and #2 (that is the device can detect transmissions from transmitters #1 and #2), labeled in the figure with an “A” and cross-hatching, the narrative might specify that an SP is detectable, even though it may have an effective location outside the intersection labeled “A.” For example, the narrative may have computed that the effective location of the simulated phenomena is in the intersection of regions #2 and #3, labeled in the figure with a “B” and hatching. The narrative may indicate that a simulated phenomenon is close by the user, but not yet within vicinity. Alternative, if the device demonstrates or indicates that it is located in region “A” and if the range of the device is not deemed to include region “B,” then the narrative may not indicate presence of the SP at all. The user of the mobile device may have no idea that physical regions #1 and #2 (or their intersection) exist—only that the SP is suddenly present and perhaps some indication of relative distance based upon the apparent (real or narrative controlled) range of the device.

In addition, by controlling the apparent position of an SP, the narrative may in effect “guide” the user of the mobile device to a particular location. For example, the narrative can indicate the position of an SP at a continuous relative distance to the (indicator of the) user, provided the location of the mobile device travels through and to the region desired by the narrative, for example along a path from region #2, through region #5, to region #1. If the mobile device location instead veers from this path (travels from region # 2 directly to region #1 by passing region #5, the narrative can detect this situation and communicate with the user, for example indicating that the SP has become further away or undetectable (the user might be considered (“lost”).

A device might also be able to sense its location in the physical world based upon a signal “grid” as provided, for example, by GPS-enabled systems. A GPS-enabled mobile device might be able to sense not only that it is in a physical region, such as receiving transmissions from transmitter #5, but it also might be able to determine that it is in a particular rectangular grid within that region, as indicated by rectangular regions #6-9. This information may be used to give GPS-enabled device a finer degree of detection than that available from cell phones, for example. One example such device is a Compaq iPaq H3850, with a Sierra wireless AirCard 300 using AT&T Wireless Internet Service and a Transplant Computing GPS card. In addition, cell phones that use the Qualcomm MSM6100 chipset have the same theoretical resolution as any other GPS. Also, an example of a fat-client mobile device is the Garmin IQue 3600, which is a PDA with GPS capability.

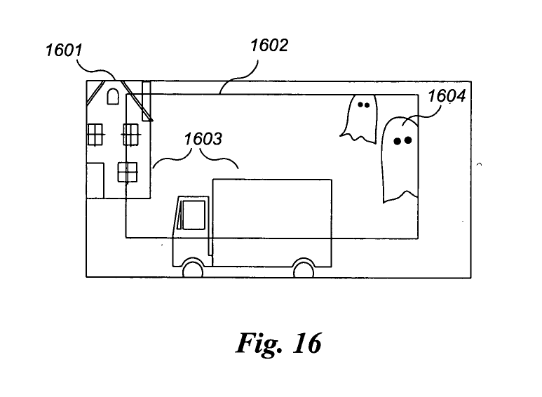

Other devices present more complicated location modeling considerations and opportunities for integration of simulated phenomena into the real world. For example, a wearable display device, such as Wireless 3D Glasses from the eDimensionali company, allows a user to “see” simulated phenomena in the same field of vision as real world objects, thus providing a kind of “augmented reality.” FIG. 16 is an example illustration of an example field of vision on a display of a wearable device. The user's actual vision is the area demarcated as field of vision 1601. The apparent field of vision supported by the device is demarcated by field of vision 1602. Using SPIS technology, the user can see real world objects 1603 and simulated phenomena 1604 within the field 1602. One skilled in the art will recognize that appropriate software modeling can be incorporated into a phenomenon modeling component or the simulated phenomena attributes data repository to account for the 3D modeling supported by such devices and enhance them to represent simulated phenomena in the user's field of view.

PDAs with IRDA (infrared) capabilities, for example, a Tungsten T PDA manufactured by Palm Computing, also present more complicated modeling considerations and allows additionally for the detection of device orientation. Though this PDA supports multiple wireless networking functions (e.g., Bluetooth & Wi-Fi expansion card), the IRDA version utilizes its Infrared Port for physical location and spatial orientation determination. By pointing the infrared transmitter at an infrared transceiver (which may be an installed transceiver, such as in a wall in a room, or another infrared device, such as another player using a PDA/IRDA device), the direction the user is facing can be supplied to the simulation engine for modeling as well. This measurement may result in producing more “realistic” behavior in the simulation. For example, the simulation engine may be able to better detect when a user has actually pointed the device at an SP to capture it. Similarly, the simulation engine can also better detect two users facing their respective devices at each other (for example, in a simulated battle). Thus, depending upon the device, it may be possible for the SPIS to produce SPs that respond to orientation characteristics of the mobile device as well as location.

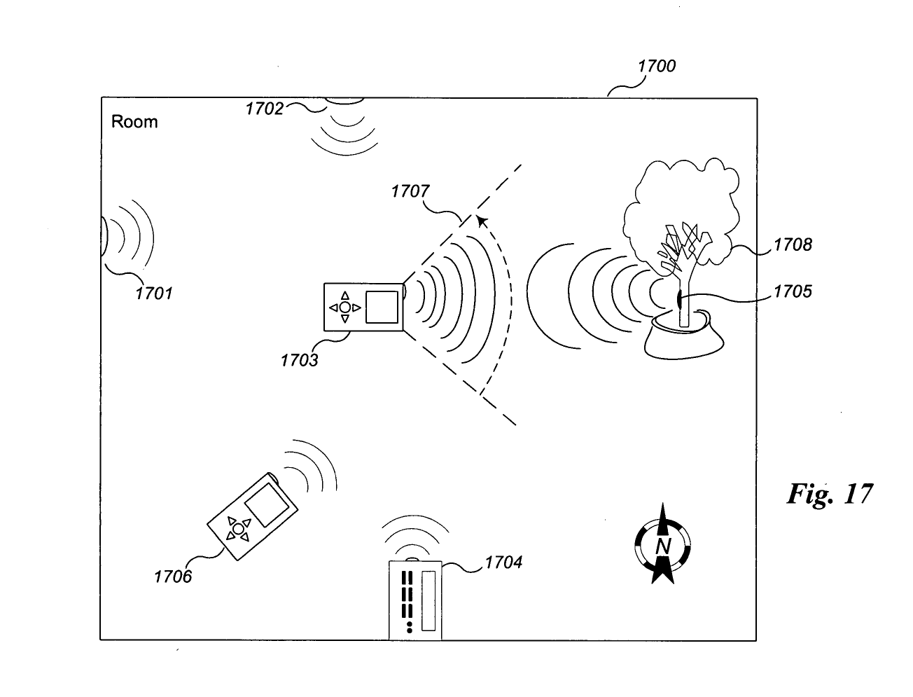

FIG. 17 is an example diagram illustrating simulation engine modeling of a mobile device enhanced with infrared capabilities whose location is sensed by infrared transceivers. In FIG. 17, two users of infrared capable mobile devices 1703 and 1706 are moving about a room 1700. In room 1700, there are planted various infrared transceivers 1702, 1704, and 1705 (and the transceivers in each mobile device 1703 and 1706), which are capable of detecting and reporting to the simulation engine the respective locations (and even orientations) of the mobile devices 1703 and 1706. 1701 represents a not-networked infrared source which blinks with a pattern that is recognized by the mobile device. Though no information is transferred from the infrared source to the simulation system, the system can none the less potentially recognize the emitted pattern as the identification of an object in a particular location in the real-world. A simulated phenomenon may even be integrated as part of one of these transceivers, for example, on plant 1708 as embodied in transceiver 1705. The transceiver reported location information can be used by the simulation engine to determine more accurately what the user is attempting to do by where the user is pointing the mobile device. For example, as currently shown in FIG. 17, only the signal from the plant (if the plant is transmitting signals, or, alternatively, the receipt of signal from the device 1703) is within the actual device detection field 1707 of device 1703. Thus, the simulation engine can indicate that the SP associated with plant 1708 is detectable or otherwise capable of interaction.

One skilled in the art will recognize that, in general, other devices with other types of location detection can also be incorporated into SPIS in a similar manner to incorporating detection using PDAs with IRDA. Many types of local location determination (determination local to the mobile device) can be employed. For example, a mobile device enhanced with the ability to detect radio frequency, ultrasonic, or other broadcast identification can also be incorporated. Transmitters that broadcast such signals can be placed in an environment similar to that illustrated in FIG. 17 so as to enhance the user's experience. When the mobile device detects these broadcasted signals, they can be communicated to the simulation engine. Alternatively, remote location determination (determination external to the mobile device) can be used. Accordingly, whatever broadcasting technique is incorporated, the mobile device may be outfitted with the transmitter, and appropriate receivers placed in the environment that communicate with the simulation engine when they detect the mobile device. Additional mathematical modeling, such as triangulation, can be used to hone in on the location of the device when multiple sensors are placed. Both local and remote location determination may be particularly useful to determine the location of an enhanced mobile device having GPS capabilities as it moves from, for example, outside where satellite detection is possible, to inside a locale where other methods of device location detection (or simulation/estimation by the narrative) are employed. An example system that provides detection inside a locale using a model of continuous degradation with partial GPS capability is Snaptrack by Qualcomm.

One skilled in the art will also recognize that there are inherent inconsistencies and limitations as to the accuracy of sampling data from all such devices. For example, broadcasting methodologies used in location determination as described above can be blocked, reflected, or distorted by the environment or other objects within the environment. Preferably, the narrative handles such errors, inconsistencies, and ambiguities in a manner that is consistent with the narrative context. For example, in the gaming system called “Spook” described earlier, when the environmental conditions provide insufficient reliability or precision in location determination, the narrative might send an appropriate text message to the user such as “Ghosts have haunted your spectral detector! Try to shake them by walking into an open field.” Also, some devices may necessitate that different techniques be used for location determination and the narrative may need to adjust accordingly and dynamically. For example, a device such as a GPS might have high resolution outdoors, but be virtually undetectable (and thus have low location resolution) indoors. The narrative might need to specify the detectability of an SP at that point in a manner that is independent from the actual physical location of the device, yet still gives the user information. Dependent upon the narrative, the system may choose to indicate that the resolution has changed or not.

A variety of techniques can be used to indicate detectability of an SP when location determination becomes degraded, unreliable, or lost. For example, the system can display its location in courser detail (similar to a “zoom out” effect). Using this technique the view range is modified to cover a larger area, so that the loss of location precision does not create a view that continuously shifts even though the user is stationary. If the system loses location determination capability completely, the device can use the last known position. Moreover, if the shape of the degraded or occluded location data area is known, the estimated or last-known device position can be shown as a part of a boundary of this area. For example, if the user enters a rectangular building that blocks all location determination signals, the presentation to the user can show the location of the user as a point on the edge of a corresponding rectangle. The view presented to the user will remain based on this location until the device's location can be updated. Regardless of the ability to determine the device's precise location, SP locations can be updated relative to whatever device location the simulation uses.

As mentioned, the physical location of the device may be sent with the interaction request itself or may have been sent earlier as part of some other interaction request, or may have been indicated to the simulation engine by some kind of sensor somewhere else in the environment. Once the simulation engine receives the location information, the narrative can determine or modify the behavior of an SP relative to that location.

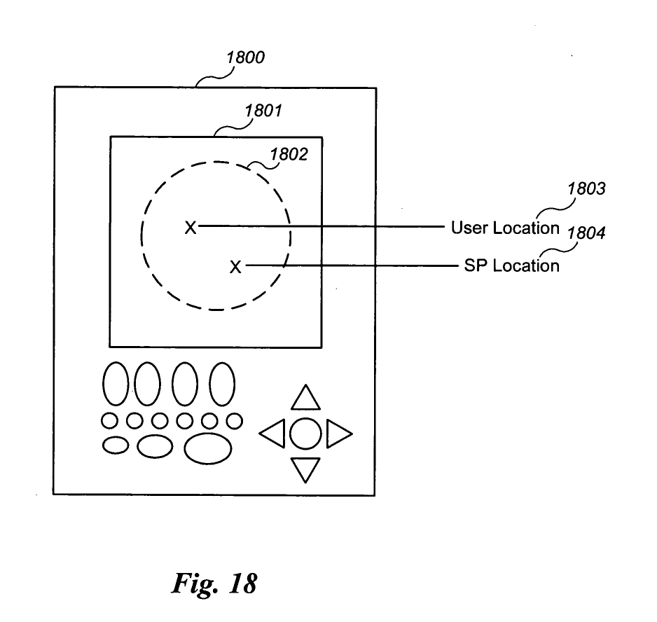

FIG. 18 is an example illustration of a display on a mobile device that indicates the location of a simulated phenomenon relative to a user's location as a function of the physical location of the mobile device. As shown, the mobile device 1800 is displaying on the display screen area 1801 an indication in the “spectral detection field” 1802 of the location of a particular SP 1804 relative to the user's location 1803. In an example scenario, the location of the SP 1804 would be returned from the narrative engine in response to a detection interaction request. As described with respect to FIG. 15, the relative SP location shown is not likely an absolute physical distance and may not divulge any information to the user about the location modeling being employed in the narrative engine. Rather, the difference between the user's location 1803 and the SP location 1804 is dictated by the narrative and may move as the user moves the mobile device to indicate that the user is getting closer or farther from the SP. These aspects are typically controlled by the narrative logic and SP/device specific. There are many ways that the distances between the SP and a user may be modeled. FIG. 18 just shows one of them.

Indications of a simulated phenomenon relative to a mobile device are also functions of both the apparent range of the device (area in which the device “operates” for the purposes of the simulation engine) and the apparent range of the sensitivity function(s) used for interactions. The latter (sensitivity range) is typically controlled by the narrative engine but may be programmed to be related to the apparent range of the device. Thus, for example, in FIG. 18, the apparent range of the spectra-meter is shown by the dotted line of the detection field 1802. The range of the device may also be controlled by the logic of the narrative engine and have nothing to do with the actual physical characteristics of the device, or may be supplemented by the narrative logic. For example, the range of the spectra-meter may depend on the range of the sensitivity function programmed into the simulator engine. For example, a user may be able to increase the range (sensitivity) of the sensitivity function and hence the apparent range of the device by adjusting some attribute of the device, which may be imaginary. For example, the range of the spectra-meter may be increased by decreasing the device's ability to display additional information regarding an SP, such as a visual indication of the identity or type of the SP, presumably yielding more “power” to the device for detection purposes rather than display purposes.

Although the granularity of the actual resolution of the physical device may be constrained by the technology used by the physical device, the range of interaction, such as detectability, that is supported by the narrative engine is controlled directly by the narrative engine. Thus, the relative size between what the mobile device can detect and what is detectable may be arbitrary or imaginary. For example, although a device might have an actual physical range of 3 meters for a GPS, 30 meters for a WiFi connected device, or 100-1000 meters for cell phones, the simulation engine may be able to indicate to the user of the mobile device that there is a detectable SP 200 meters away, although the user might not yet be able to use a communication interaction to ask questions of it at this point.

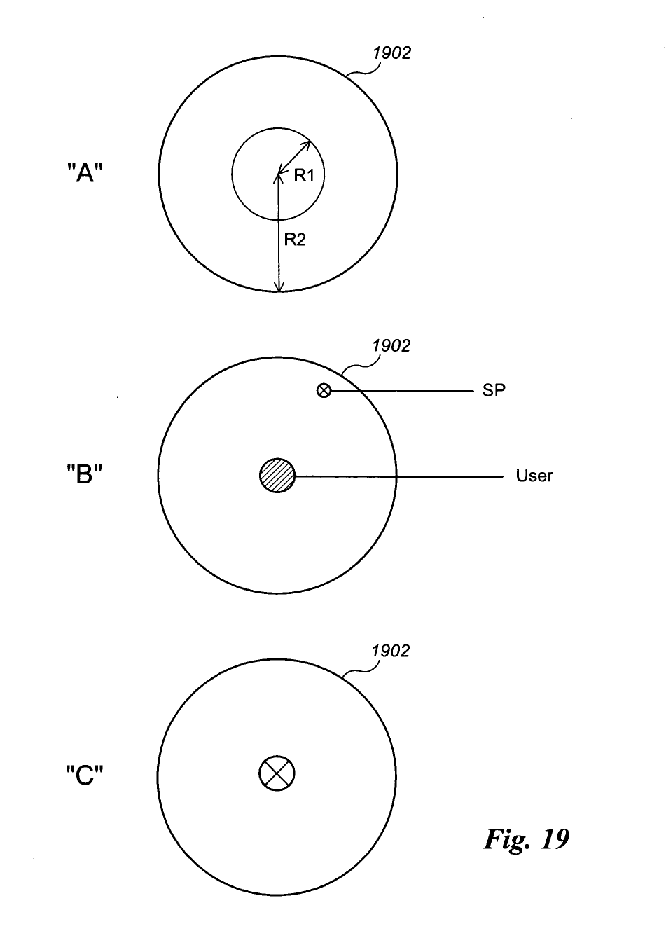

FIG. 19 contains a set of diagrams illustrating different ways to determine and indicate the location of a simulated phenomenon relative to a user when a device has a different physical range from its apparent range as determined by the simulation engine. In Diagram A, the apparent range circumscribed by radius R2 represents the strength of a detection field 1902 in which an SP can be detected by a mobile device having an actual physical detection range determined by radius R1. For example, if the mobile device is a GPS, R1 may be 3 meters, whereas R2 may be (and typically would be) a large multiple of R1 such as 300 meters.

In Diagram B, the smaller circle indicates where the narrative has located the SP is relative to the apparent detection range of the device. The larger circle in the center indicates the location of the user relative to this same range and is presumed to be a convention of the narrative in this example. When the user progresses to a location that is in the vicinity of an SP (as determined by whatever modeling technique is being used by the narrative engine), then, as shown in Diagram C, the narrative indicates to the user that a particular SP is present. (The big “X” in the center circle might indicate that the user is in the same vicinity as the SP.) This indication may need to be modified based upon the capabilities and physical limitations of the device. For example, if a user is using a device, such as a GPS, that doesn't work inside a building and the narrative has located the SP inside the building, then the narrative engine may need to change the type of display used to indicate the SP's location relative to the user. For example, the display might change to a map that shows an inside of the building and indicate an approximate location of the SP on that map even though movement of the device cannot be physically detected from that point on. One skilled in the art will recognize that a multitude of possibilities exist for displaying relative SP and user locations based upon and taking into account the physical location of the mobile device and other physical parameters and that the user will perceive the “influence” of the SP on the user's physical environment as long as it continues to be related back to that physical environment.

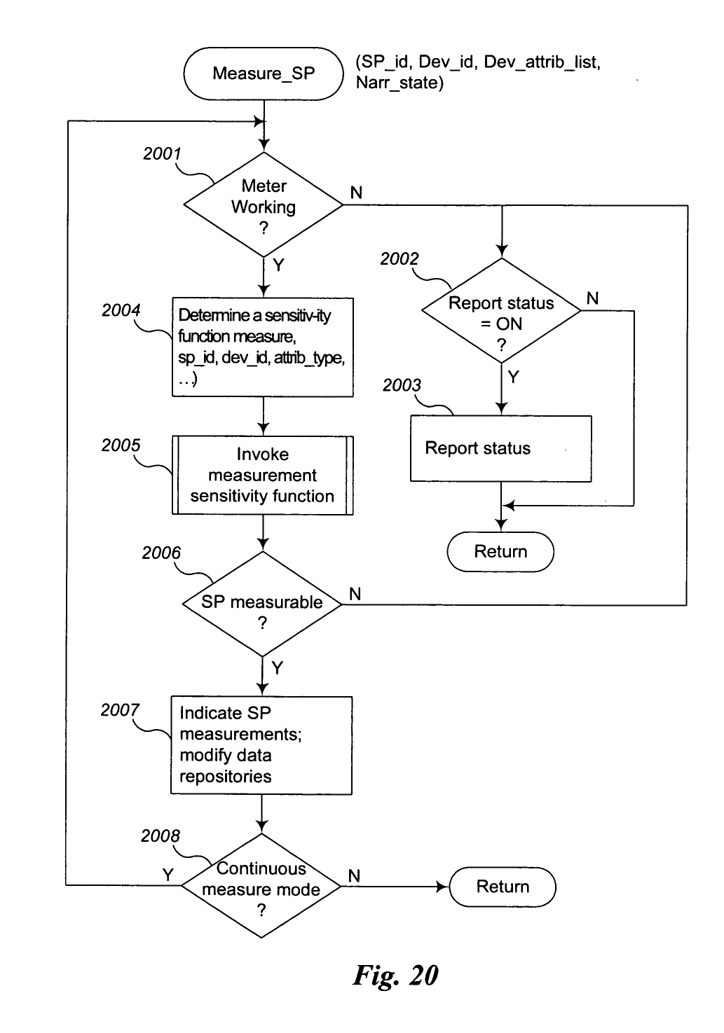

FIG. 20 is an example flow diagram of an example measurement interaction routine provided by a simulation engine of a Simulated Phenomena Interaction System. This routine may reside and be executed by the narrative engine portion of the simulation engine. It allows a user via a mobile device to “measure” characteristics of an SP to obtain values of various SP attributes. For example, although “location” is one type of attribute that can be measured (and detected), other attributes such as the “color,” “size,” “orientation,” “mood,” “temperament,” “age,” etc. may also be measured. The definition of an SP in terms of the attributes an SP supports or defines will dictate what attributes are potentially measurable. Note that each attribute may support a further attribute which determines whether a particular attribute is currently measurable or not. This latter degree of measurability may be determine by the narrative based upon or independent of other factors such as the state of the narrative, or the particular device, user, etc.

Specifically, in step 2001, the routine determines whether the measurement meter is working, and, if so, continues in step 2004 else continues in step 2002. This determination is conducted from the point of view of the narrative, not the mobile device (the meter). Thus, although the metering device appears to be working correctly, the narrative may dictate a state in which the device appears to be malfunctioning. In step 2002, the routine, because the meter is not working, determines whether the device has designated or previously indicated in some manner that the reporting of status information is desirable. If so, the routine continues in step 2003 to report status information to the mobile device (via the narrative engine) and then returns. Otherwise, the routine simply returns without measuring anything or reporting information. In step 2004, when the meter is working, the routine determines whether a sensitivity function exists for a measurement interaction routine based upon the designated SP identifier, device identifier, and the type of attribute that the measurement is measuring (the type of measurement), and similar parameters. As described with reference to Tables 1 and 2, there may be one sensitivity function that needs to be invoked to complete the measurement of different or multiple attributes of a particular SP for that device. Once the appropriate sensitivity function is determined, then the routine continues in step 2005 to invoke the determined measurement sensitivity function. Then, in step 2006, the routine determines as a result of invoking the measurement related sensitivity function, whether the simulated phenomenon was measurable, and if so, continues in step 2007, otherwise continues in step 2002 (to optionally report non-success). In step 2007, the routine indicates the various measurement values of the SP (from attributes that were measured) and modifies or updates any data repositories and state information as necessary to update the state of the SP, narrative, and potentially the simulated engine's internal representation of the mobile device, to consider the SP “measured.” In step 2008, the routine determines whether the device has previously requested to be in a continuous measurement mode, and, if so, continues in step 2001 to begin the measurement loop again, otherwise returns.

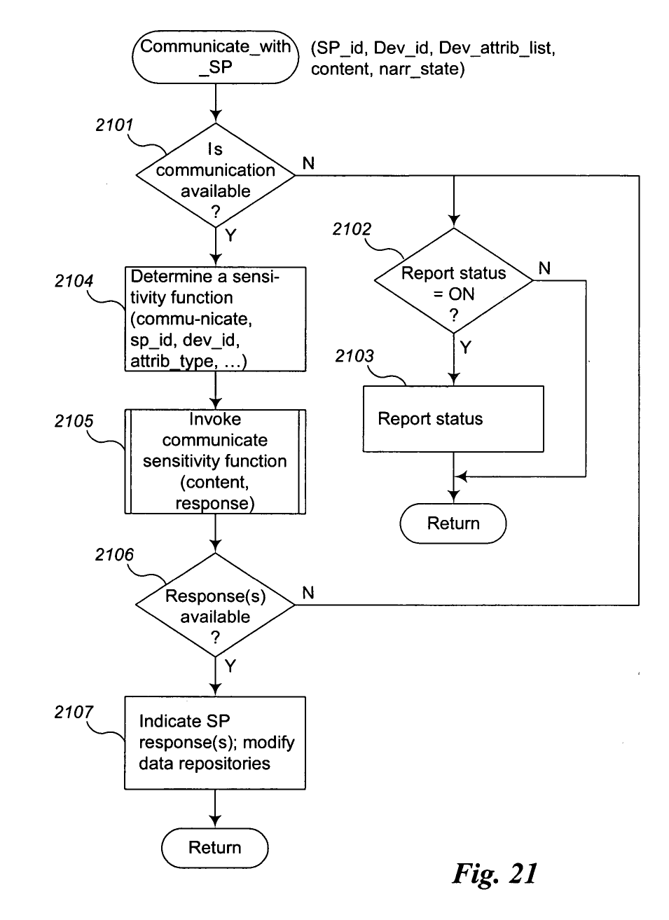

FIG. 21 is an example flow diagram of an example communicate interaction routine provided by a simulation engine of a Simulated Phenomena Interaction System. This routine may reside and be executed by the narrative engine portion of the simulation engine. It allows a user via a mobile device to “communicate” with a designated simulated phenomenon. For example, communication may take the form of questions to be asked of the SP. These may be pre-formulated questions (retrieved from a data repository and indexed by SP, for example) which are given to a user in response to any request that indicates that the user is attempting communication with the SP, such as by typing: Talk or by pressing a Talk button. Alternatively, the simulation engine may incorporate an advanced pattern matching or natural language engine similar to a search tool. The user could then type in a newly formulated question. (not canned) and the simulation engine attempt to answer it or request clarification. In addition, the SP can communicate with the user in a variety of ways, including changing some state of the device to indicate its presence, for example, blinking a light. Or, to simulate an SP speaking to a mobile device that has ringing capability (such as a cell phone), the device might ring seemingly unexpectedly. Also, preformulated content may be streamed to the device in text, audio, or graphic form, for example. One skilled in the art will recognize that many means to ask questions or hold “conversations” with an SP exist, or will be developed, and such methods can be incorporated into the logic of the simulation engine as desired. Whichever method is used, the factors that are to be considered by the SP in its communication with the mobile device are typically designated as input parameters. For example, an identifier of the particular SP being communicated with, an identifier of the device, and the current narrative state may be designated as input parameters. In addition, a data structure is typically designated to provide the message content, for example, a text message or question to the SP. The communication routine, given the designated parameters, determines whether communication with the designated SP is currently possible, and if so, invokes a function to “communicate” with the SP, for example, to answer a posed question.

Specifically, in step 2101, the routine determines whether the SP is available to be communicated with, and if so, continues in step 2104, else continues in step 2102. This determination is conducted from the point of view of the narrative, not the mobile device. Thus, although the mobile device appears to be working correctly, the narrative may dictate a state in which the device appears to be malfunctioning. In step 2102, the routine, because the SP is not available for communication, determines whether the device has designated or previously indicated in some manner that the reporting of such status information is desirable. If so, the routine continues in step 2103 to report status information to the mobile device of the incommunicability of the SP (via the narrative engine), and then returns. Otherwise, if reporting status information is not desired, the routine simply returns without the communication completing. In step 2104, when the SP is available for communication, the routine determines whether there is a sensitivity function for communicating with the designated SP based upon the other designated parameters. If so, then the routine invokes the communication sensitivity function in step 2105 passing-along the content of the desired communication and a designated output parameter to which the SP can indicate its response. By indicating a response, the SP is effectively demonstrating its behavior based upon the current state of its attributes, the designated input parameters, and the current state of the narrative. In step 2106, the routine determines whether a response has been indicated by the SP, and, if so, continues in step 2107, otherwise continues in step 2102 (to optionally report non-success). In step 2107, the routine indicates that the SP returned a response and the contents of the response, which is eventually forwarded to the mobile device by the narrative engine. The routine also modifies or updates any data repositories and state information to reflect the current state of the SP, narrative, and potentially the simulated engine's internal representation of the mobile device to reflect the recent communication interaction. The routine then returns.

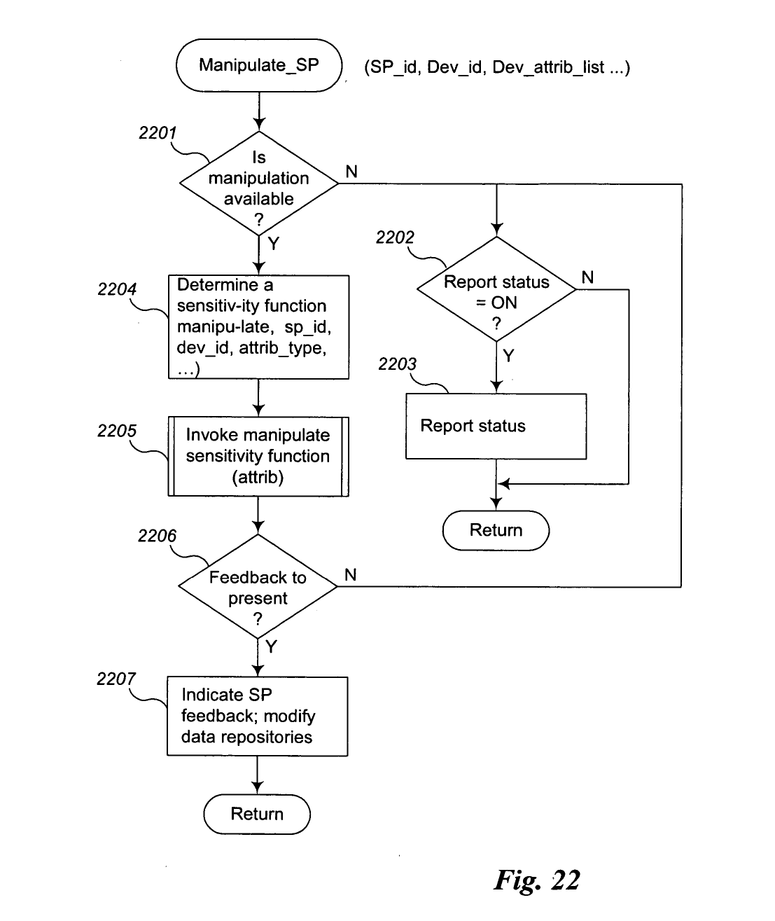

FIG. 22 is an example flow diagram of an example manipulation interaction routine provided by a simulation engine of a Simulated Phenomena Interaction System. This routine may reside and be executed by the narrative engine portion of the simulation engine. It may be invoked by a user to affect some characteristic of the SP by setting a value of the characteristic or to alter the SPs behavior in some way. For example, in the Spook game, a user invokes a manipulation interaction to vacuum up a ghost to capture it. As another example, in the training scenario, a manipulation interaction function may be used to put a (virtual) box around a contaminant where the box is constructed of a certain material to simulate containment of the contaminating material (as deemed by the narrative). As with the other interaction routines, different characteristics and attributes may be designated as input parameters to the routine in order to control what manipulation sensitivity function is used. Accordingly, there may be specific manipulation functions not only associated with the particular SP but, for example, by which button a user depresses on the mobile device. So, for example, if, for a specific simulation, the

1. A computer-based commerce-enabled environment for interacting with a simulation scenario, comprising:
a data repository that stores attribute values associated with a computer-controlled simulated phenomenon;
simulation control flow logic that is structured to
receive an indication from a participant in the simulation scenario to interact with the simulated phenomenon;
perform the indicated interaction based upon the stored attribute values of the simulated phenomenon and a physical characteristic associated with a mobile device whose value has been sensed from the real world; and
based upon the performed interaction, cause an action to occur that affects an outcome in the simulation scenario; and
a commerce-enabled interface that provides facilities to a non-participant of the simulation scenario to purchase an opportunity to participate in the simulation scenario.

2. The commerce-enabled environment of claim 1 wherein the outcome that: is affected by the action relates to at least one of the simulated phenomenon, the mobile device, the participant, a narrative associated with the simulation scenario, or the result of the performed interaction.

3. The commerce-enabled environment of claim 1 wherein the opportunity to participate in the simulation scenario comprises causing the environment to change a stored attribute value associated with the computer-controlled simulated phenomenon.

4. The commerce-enabled environment of claim 1 wherein the opportunity to participate in the simulation scenario comprises causing the environment to assist the participant.

5. The commerce-enabled environment of claim 4 wherein the assistance is performed by presenting assisting information to the participant.

6. The commerce-enabled environment of claim 5 wherein the assisting information is in the form of a hint regarding interacting with the computer-controlled simulated phenomenon.

7. The commerce-enabled environment of claim 5 wherein the assisting information is in a hint based upon a narrative associated with the simulation control flow logic.

8. The commerce-enabled environment of claim 4 wherein the assistance is delivered to the participant as at least one of audio, visual, or tactile information.

9. The commerce-enabled environment of claim 1, further comprising a plurality of participants, and wherein the opportunity to participate is directed to assisting one of the plurality of participants.

10. The commerce-enabled environment of claim 1 wherein the opportunity to participate in the simulation scenario is controlled by a narrative associated with the simulation control flow logic.

11. The commerce-enabled environment of claim 1, the purchase having an associated cost related to the opportunity to participate.

12. The commerce-enabled environment of claim 11 wherein the cost is based upon a desired action that effects an outcome in the simulation scenario.

13. The commerce-enabled environment of claim 11 further comprising a plurality of participants, wherein the cost is based upon a current status of one of the participants.

14. The commerce-enabled environment of claim 1 wherein the purchase is associated with a designated non-profit organization and funds received in the purchase are directed to the designated non-profit organization.

15. The commerce-enabled environment of claim 1 wherein the facilities to purchase provide a plurality of opportunities to purchase and each purchase is associated with a potentially different designated organization and funds received in the purchase are directed to the appropriate designated organization.

16. The commerce-enabled environment of claim 15 wherein the organization is a charity.

17. The commerce-enabled environment of claim 15 wherein the organization is a for-profit entity.

18. The commerce-enabled environment of claim 1 wherein the purchase is associated with a designated for-profit entity and funds received in the purchase are directed to the designated for-profit organization.

19. The commerce-enabled environment of claim 1 wherein the commerce-enabled interface comprises:
a commerce related data repository that stores data associated with transactions involving opportunities to participate in the simulation scenario; and
a non-participant support module that is structured to provide an interface to a non-participant to facilitate the purchase of the opportunity and to interact with a financial transaction server that validates and authorizes payment used to purchase the opportunity.

20. The commerce-enabled environment of claim 19 wherein the commerce-enabled interface comprises at least one of a participant support module or an administrator support module.

21. The commerce-enabled environment of claim 1 wherein the opportunity to participate in the simulation scenario comprises placing a wager related to some aspect of the simulation scenario.

22. The commerce-enabled environment of claim 21 wherein the wager relates to a measure of success of the participant.

23. The commerce-enabled environment of claim 21 wherein the wager relates to a measure of success of the computer-controlled simulation phenomenon.

24. The commerce-enabled environment of claim 21 further comprising a plurality of participants, wherein the wager relates to an outcome associated with one of the participants.

25. The commerce-enabled environment of claim 1 wherein the non-participant is a spectator.

26. The commerce-enabled environment of claim 25 wherein the spectator is associated with a set of access rights associated with the simulation scenario.

27. The commerce-enabled environment of claim 25, further comprising a plurality of participants, wherein the spectator can observe progress of each of the participants towards an outcome associated with the simulation scenario.

28. The commerce-enabled environment of claim 1, further comprising an interface that defines levels of participation in the simulation, each level associated with a set of access rights to aspects of the simulation scenario.

29. The commerce-enabled environment of claim 28 wherein the levels of participation include one or more of a participant operator, an administrator, a team member, an anonymous spectator, and an authenticated spectator.

30. The commerce-enabled environment of claim 28 wherein the access rights control what aspects of the simulation scenario are viewable at each level.

31. The commerce-enabled environment of claim 28 wherein the access rights control what aspects of the simulation scenario are modifiable at each level.

32. The commerce-enabled environment of claim 1 wherein the simulation scenario is a mobile computer game.

33. The commerce-enabled environment of claim 1, further comprising a plurality of participants, wherein the participants cooperate to provide a multiplayer gaming environment.

34. The commerce-enabled environment of claim 33 wherein the non-participant purchases the opportunity to participate in a team with one of the participants.

35. The commerce-enabled environment of claim 1 wherein the simulation scenario is a computer-based simulation training environment.

36. The commerce-enabled environment of claim 35 wherein the simulation training environment is used to simulate bio-hazardous substance detection.

37. The commerce-enabled environment of claim 35 wherein the simulation phenomenon is related to at least one of weather, natural hazards, weapons, man-made hazards, diseases, contagions, or airborne particles.

38. The commerce-enabled environment of claim 35 wherein the simulated phenomenon is related to at least one of nuclear, biological, or chemical weapons.

39. The commerce-enabled environment of claim 1 wherein the commerce-enabled interface operates over a network.

40. The commerce-enabled environment of claim 1 wherein the commerce-enabled interface operates over at least one of the Internet, a wired network, a wireless communications network, or an intermittent connection.

41. The commerce-enabled environment of claim 1 wherein the interaction is at least one of detecting, measuring, communicating with, or manipulating.

42. The commerce-enabled environment of claim 1 wherein the physical characteristic is associated with a location of the mobile device associated with the participant.

43. The commerce-enabled environment of claim 1 wherein the physical characteristic is associated with an orientation aspect of the mobile device associated with the participant.

44. The commerce-enabled environment of claim 1 wherein the simulated phenomenon simulates at least one of a real world event or a real world object.

45. The commerce-enabled environment of claim 1 wherein the simulation scenario is constructed using a simulation authoring system.

46. The commerce-enabled environment of claim 45 wherein the simulation authoring system localizes the simulation scenario to a real world physical location.

47. A computer-based method for enabling commerce related to interacting with a simulation scenario, comprising:
storing attribute values associated with a computer-controlled simulated phenomenon;
receiving an indication from a participant in the simulation scenario to interact with the simulated phenomenon;
performing the indicated interaction based upon the stored attribute values of the simulated phenomenon and a physical characteristic associated with a mobile device whose value has been sensed from the real world;
causing an action to occur based upon the performed interaction, the action affecting an outcome in the simulation scenario; and
receiving an indication of a purchased opportunity to participate in the simulation scenario.

48. The method of claim 47 wherein the receiving the indication of the purchased opportunity indicates that the opportunity was purchased by a non-participant of the simulation scenario.

49. The method of claim 47 wherein the outcome that is affected by the action relates to at least one of the simulated phenomenon, the mobile device, the participant, a narrative associated with the simulation scenario, or the result of the performed interaction.

50. The method of claim 47, further comprising:
in exchange for the purchase, causing the environment to change a stored attribute value associated with the computer-controlled simulated phenomenon.

51. The method of claim 47, further comprising:
in exchange for the purchase, causing the environment to assist the participant.

52. The method of claim 51 wherein the causing the environment to assist the participant further comprises presenting assisting information to the participant.

53. The method of claim 52 wherein the presenting assisting information to the participant presents a hint regarding interacting with the computer-controlled simulated phenomenon.

54. The method of claim 52 wherein the presenting assisting information to the participant presents a hint based upon a narrative associated with the simulation control flow logic.

55. The method of claim 51 wherein the causing the environment to assist the participant further comprises delivering to the participant assistance in a form of as at least one of audio, visual, or tactile information.

56. The method of claim 47, the receiving of the indication of the purchased opportunity to participate further comprising receiving an indication that the purchased opportunity is directed to assisting one of a plurality of participants.

57. The method of claim 47, further comprising:
performing the purchased opportunity by performing an action that is controlled by a narrative associated with the simulation scenario.

58. The method of claim 47 wherein the receiving the indication of the purchased opportunity further comprises receiving an indication of an associated cost related to the opportunity to participate.

59. The method of claim 58 wherein the associated cost is based upon a desired action that effects an outcome in the simulation scenario.

60. The method of claim 58 wherein the associated cost is based upon a current status of one of a plurality of participants in the simulation scenario.

61. The method of claim 47 wherein the receiving the indication of the purchased opportunity further comprises:
receiving an indication of a purchased opportunity, the purchase associated with a designated non-profit organization; and
directing funds to the designated non-profit organization.

62. The method of claim 47, further comprising a plurality of opportunities to purchase each associated with a potentially different designated organization, and wherein the receiving the indication of the purchased opportunity further comprises receiving an indication of a purchase of one of the plurality of opportunities and an indication of a designated organization to receive funds associated with the purchase.

63. The method of 62, further comprising:
directing funds to the indicated designated organization.

64. The method of claim 62 wherein the indicated organization is a charity.

65. The method of claim 62 wherein the indicated organization is a for-profit entity.

66. The method of claim 47 wherein the receiving the indication of the purchased opportunity further comprises:
receiving an indication of a purchased opportunity, the purchase associated with a designated for-profit entity.

67. The method of 66, further comprising:
directing funds to the indicated designated for-profit entity.

68. The method of claim 47, further comprising:
receiving an indication from a financial transaction server that validates and authorizes a payment used to purchase the opportunity to participate in the simulation scenario.

69. The method of claim 47 wherein the receiving the indication of the purchased opportunity further comprises:
receiving an indication of a purchased opportunity, the purchase associated with placing a wager related to some aspect of the simulation scenario.

70. The method of claim 69 wherein the wager relates to a measure of success of the participant.

71. The method of claim 69 wherein the wager relates to a measure of success of the computer-controlled simulation phenomenon.

72. The method of claim 69, further comprising a plurality of participants, wherein the wager relates to an outcome associated with one of the participants.

73. The method of claim 47 wherein receiving the indication of the purchased opportunity to participate further comprises receiving an indication of a purchased opportunity, the opportunity having been purchased by a spectator.

74. The method of claim 73 wherein the spectator is associated with a set of access rights associated with the simulation scenario.

75. The method of claim 73, the simulation scenario involving a plurality of participants, and further comprising:
allowing the spectator to observe progress of each of the participants towards an outcome associated with the simulation scenario.

76. The method of claim 47, further comprising:
defining levels of participation in the simulation, each level associated with a set of access rights to aspects of the simulation scenario.

77. The method of claim 76 wherein the levels of participation include one or more of a participant operator, an administrator, a team member, an anonymous spectator, and an authenticated spectator.

78. The method of claim 76 wherein the access rights control what aspects of the simulation scenario are viewable at each level.

79. The method of claim 76 wherein the access rights control what aspects of the simulation scenario are modifiable at each level.

80. The method of claim 47 wherein the simulation scenario is a mobile computer game.

81. The method of claim 47, the simulation scenario involving a plurality of participants, and wherein the participants cooperate to provide a multiplayer gaming environment.

82. The method of claim 81 wherein the receiving the indication of the purchased opportunity comprises receiving an indication that a non-participant has purchased an opportunity to participate in a team with one of the participants.

83. The method of claim 47 wherein the simulation scenario is a computer-based simulation training environment.

84. The method of claim 83 wherein the simulation training environment is used to simulate bio-hazardous substance detection.

85. The method of claim 83 wherein the simulation phenomenon is related to at least one of weather, natural hazards, weapons, man-made hazards, diseases, contagions, or airborne particles.

86. The method of claim 83 wherein the simulated phenomenon is related to at least one of nuclear, biological, or chemical weapons.

87. The method of claim 47 wherein the receiving the indication of the purchased opportunity receives an indication of a purchased opportunity to participate over a network.

88. The method of claim 47 wherein the network comprises at least one of the Internet, a wired network, a wireless communications network, or an intermittent connection.

89. The method of claim 47 wherein the performing the interaction further comprises performing an interaction that is at least one of detecting, measuring, communicating with, or manipulating.

90. The method of claim 47 wherein the physical characteristic is associated with a location associated with a participant in the simulation scenario.

91. The method of claim 47 wherein the physical characteristic is associated with an orientation aspect associated with a participant in the simulation scenario.

92. The method of claim 47 wherein the simulated phenomenon simulates at least one of a real world event or a real world object.

93. The method of claim 47, further comprising:
constructing the simulation scenario using a simulation authoring system.

94. The method of claim 93, further comprising:
localizing the simulation scenario to a real world physical location using the simulation authoring system.

95. A computer-readable memory medium containing instructions for controlling a computer processor to enable commerce related to interacting with a simulation scenario, by:
storing attribute values associated with a computer-controlled simulated phenomenon;
receiving an indication from a participant in the simulation scenario to interact with the simulated phenomenon;
performing the indicated interaction based upon the stored attribute values of the simulated phenomenon and a physical characteristic associated with a mobile device whose value has been sensed from the real world;
causing an action to occur based upon the performed interaction, the action affecting an outcome in the simulation scenario; and
receiving an indication of a purchased opportunity to participate in the simulation scenario.

96. The memory medium of claim 95 wherein the receiving the indication of the purchased opportunity indicates that the opportunity was purchased by a non-participant of the simulation scenario.

97. The memory medium of claim 95 wherein the outcome that is affected by the action relates to at least one of the simulated phenomenon, the mobile device, the participant, a narrative associated with the simulation scenario, or the result of the performed interaction.

98. The memory medium of claim 95, further comprising instructions that control the computer processor by:
in exchange for the purchase, causing the environment to change a stored attribute value associated with the computer-controlled simulated phenomenon.

99. The memory medium of claim 95, further comprising instructions that control the computer processor by:
in exchange for the purchase, causing the environment to assist the participant.

100. The memory medium of claim 99 wherein the causing the environment to assist the participant presents assisting information to the participant.

101. The memory medium of claim 100 wherein the assisting information presents a hint regarding interacting with the computer-controlled simulated phenomenon.

102. The memory medium of claim 100 wherein the assisting information presents a hint based upon a narrative associated with the simulation control flow logic.

103. The memory medium of claim 99 wherein the causing the environment to assist the participant delivers assistance to the participant in a form of as at least one of audio, visual, or tactile information.

104. The memory medium of claim 95 wherein the opportunity to participate is-directed to assisting one of the plurality of participants.

105. The memory medium of claim 95, further comprising instructions that control the computer processor by:
performing the purchased opportunity by performing an action that is controlled by a narrative associated with the simulation scenario.

106. The memory medium of claim 95 wherein the purchased opportunity is associated with a cost.

107. The memory medium of claim 106 wherein the associated cost is based upon a desired action that effects an outcome in the simulation scenario.

108. The memory medium of claim 106 wherein the associated cost is based upon a current status of one of a plurality of participants in the simulation scenario.

109. The memory medium of claim 95 wherein the purchase is associated with a designated non-profit organization.

110. The memory medium of claim 109, further comprising instructions that control the computer processor by directing funds to the designated non-profit organization.

111. The memory medium of claim 95, the simulation scenario presenting a plurality of opportunities to purchase, each associated with a potentially different designated organization, and wherein the receiving the indication of the purchased opportunity further comprises receiving an indication of a purchase of one of the plurality of opportunities and an indication of a designated organization to receive funds associated with the purchase.

112. The memory medium of 111, comprising instructions that control the computer processor by directing funds to the indicated designated organization.

113. The memory medium of claim 111 wherein the indicated organization is a charity.

114. The memory medium of claim 111 wherein the indicated organization is a for-profit entity.

115. The memory medium of claim 95 wherein the purchased opportunity is associated with a designated for-profit entity.

116. The memory medium of 115, comprising instructions that control the computer processor by:
directing funds to the indicated designated for-profit entity.

117. The memory medium of claim 95, comprising instructions that control the computer processor by:
receiving an indication from a financial transaction server that validates and authorizes a payment used to purchase the opportunity to participate in the simulation scenario.

118. The memory medium of claim 95 wherein the purchased opportunity is associated with placing a wager related to some aspect of the simulation scenario.

119. The memory medium of claim 118 wherein the wager relates to a measure of success of the participant.

120. The memory medium of claim 118 wherein the wager relates to a measure of success of the computer-controlled simulation phenomenon.

121. The memory medium of claim 118, further comprising a plurality of participants, wherein the wager relates to an outcome associated with one of the participants.

122. The memory medium of claim 95 wherein purchased opportunity is purchased by a spectator.

123. The memory medium of claim 122 wherein the spectator is associated with a set of access rights associated with the simulation scenario.

124. The memory medium of claim 122, the simulation scenario involving a plurality of participants, and further comprising instructions that control the computer processor by:
allowing the spectator to observe progress of each of the participants towards an outcome associated with the simulation scenario.

125. The memory medium of claim 95, further comprising instructions that control the computer processor by:
defining levels of participation in the simulation, each level associated with a set of access rights to aspects of the simulation scenario.

126. The memory medium of claim 125 wherein the levels of participation include one or more of a participant operator, an administrator, a team member, an anonymous spectator, and an authenticated spectator.

127. The memory medium of claim 125 wherein the access rights control what aspects of the simulation scenario are viewable at each level.

128. The memory medium of claim 125 wherein the access rights control what aspects of the simulation scenario are modifiable at each level.

129. The memory medium of claim 95 wherein the simulation scenario is a mobile computer game.

130. The memory medium of claim 95, the simulation scenario involving a plurality of participants, and wherein the participants cooperate to provide a multiplayer gaming environment.

131. The memory medium of claim 130 wherein purchased opportunity has been purchased by a non-participant opportunity to participate in a team with one of the participants.

132. The memory medium of claim 95 wherein the simulation scenario is a computer-based simulation training environment.

133. The memory medium of claim 132 wherein the simulation training environment is used to simulate bio-hazardous substance detection.

134. The memory medium of claim 132 wherein the simulation phenomenon is related to at least one of weather, natural hazards, weapons, man-made hazards, diseases, contagions, or airborne particles.

135. The memory medium of claim 132 wherein the simulated phenomenon is related to at least one of nuclear, biological, or chemical weapons.

136. The memory medium of claim 95 wherein the indication of the purchased opportunity is received over a network.

137. The memory medium of claim 95 wherein the network comprises at least one of the Internet, a wired network, a wireless communications network, or an intermittent connection.

138. The memory medium of claim 95 wherein the performing the interaction further comprises performing an interaction that is at least one of detecting, measuring, communicating with, or manipulating.

139. The memory medium of claim 95 wherein the physical characteristic is associated with a location associated with a participant in the simulation scenario.

140. The memory medium of claim 95 wherein the physical characteristic is associated with an orientation aspect associated with a participant in the simulation scenario.

141. The memory medium of claim 95 wherein the simulated phenomenon simulates at least one of a real world event or a real world object.

142. The memory medium of claim 95, further comprising instructions that control the computer processor by:
constructing the simulation scenario using a simulation authoring system.

143. The memory medium of claim 142, further comprising instructions that control the computer processor by:
localizing the simulation scenario to a real world physical location using the simulation authoring system.
